(19) United States
(12) Patent Application Publication
(10) Pub. No.: US 2024/0427832 A1
(43) Pub. Date: Dec. 26, 2024

(54) SYSTEM AND METHOD FOR AI-BASED GENERATION OF RESPONSIVE WEBSITES USING A WEBSITE BUILDING SYSTEM

(71) Applicant: WIX.COM LTD., Tel Aviv (IL)

(72) Inventors: Naama Ben Oliel Ronen, Tel Aviv (IL); Eliahu Brosh, Ramat Hasharon (IL); Liron Monitz, Tel Aviv (IL); Shai Hoshkover, Tel Aviv (IL); Meir Perez, Modiin (IL)

(21) Appl. No.: 18/750,403

(22) Filed: Jun. 21, 2024

Related U.S. Application Data
(60) Provisional application No. 63/662,175, filed on Jun. 20, 2024.
(60) Provisional application No. 63/509,893, filed on Jun. 23, 2023.

(51) Int. Cl. G06F 16/957; G06F 3/04845

(52) U.S. Cl. CPC G06F 16/9577; G06F 3/04845

(57) ABSTRACT

Embodiments provide for responsive optimization of websites. In some examples, a layout graph data structure is generated based on applying a trained layout model to extracted website elements from an input object including one or more website building tools. A webpage layout data structure is generated based on applying a trained structure optimization model to the layout graph data structure. An optimized webpage that is configured to render according to a plurality of screen parameters is generated based on applying a trained responsive optimization model to the webpage layout data structure and a plurality of screen parameters.

### CROSS-REFERENCE TO RELATED APPLICATIONS

The present application claims priority to U.S. Provisional Application Ser. No. 63/662,175, titled “SYSTEM AND METHOD FOR AI-BASED GENERATION OF RESPONSIVE WEBSITES USING A WEBSITE BUILDING SYSTEM,” filed Jun. 20, 2024, U.S. Provisional Application Ser. No. 63/509,893, titled “SYSTEM AND METHOD FOR PROVIDING AN AI-BASED GENERATION OF RESPONSIVE WEBSITES,” filed Jun. 23, 2023, the entire contents of both of which are incorporated herein by reference.

### TECHNOLOGICAL FIELD

The present application is directed generally to visual editing technologies and, more particularly, to a system, apparatus, method, and computer program product for AI-based generation of responsive websites using a website building system.

### BACKGROUND

Various platforms may offer capabilities associated with generation of visual content. However, integrating model interaction with the generation of such visual content is computationally complex and unpredictable. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

Embodiments relate to providing AI-based generation of responsive websites using a website building system. In some examples, a layout graph data structure is generated based on applying a trained layout model to extracted website elements from an input object including one or more website building tools. A webpage layout data structure is generated based on applying a trained structure optimization model to the layout graph data structure. An optimized webpage that is configured to render according to a plurality of screen parameters is generated based on applying a trained responsive optimization model to the webpage layout data structure and a plurality of screen parameters.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE SEVERAL VIEWS OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawings. Some embodiments may include the components arranged in a different way:

FIG. 1 illustrates an example system architecture within which embodiments of the present disclosure may operate;

FIGS. 2A, 2B, and 2C depict example operations associated with generating optimized responsive website designs in accordance with some example embodiments described herein;

FIGS. 2D and 2E depict example operations associated with layout understanding in accordance with some example embodiments described herein;

FIG. 2F depicts an example architecture for use in layout understanding in accordance with some example embodiments described herein;

FIGS. 2G, 2H, and 2I depict example operations associated with structure and layout optimization in accordance with some example embodiments described herein;

FIGS. 2J and 2K depict example operations associated with responsive optimization in accordance with some example embodiments described herein;

FIGS. 3A, 3B, 3C, 3D, 3E, and 3F depict example user interfaces in accordance with some example embodiments described herein;

FIGS. 4A, 4B, 4C, 4D, 4E, and 4F depict example user interfaces in accordance with some example embodiments described herein;

FIGS. 5A and 5B depict example detection and representation mechanisms in accordance with example embodiments described herein;

FIG. 6 illustrates a block diagram of an example system that may be specially configured within which embodiments of the present disclosure may operate;

FIG. 7 illustrates a schematic block diagram of example components of an example website building system in accordance with some example embodiments described herein;

FIG. 8 illustrates a schematic block diagram of example repositories of an example content management system of website building system in accordance with some example embodiments described herein;

FIG. 9 is a schematic block diagram of example modules for use in an example server apparatus in accordance with some example embodiments described herein; and

FIG. 10 is a schematic block diagram of example modules for use in an example client apparatus in accordance with some example embodiments described herein.

### DETAILED DESCRIPTION

One or more example embodiments now will be more fully hereinafter described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments may be practiced without these specific details (and without applying to any particular networked environment or standard). It should be understood that some, but not all embodiments are shown and described herein. Indeed, the embodiments may be embodied in many different forms, and accordingly, this disclosure should not be construed as limited to the embodiments set forth herein. Rather, these embodiments are provided so that this disclosure will satisfy applicable legal requirements. As used herein, the description may refer to a server or client device as an example “apparatus.” However, elements of the apparatus described herein may be equally applicable to the claimed system, method, and computer program product. Accordingly, use of any such terms should not be taken to limit the spirit and scope of embodiments of the present disclosure.

Example embodiments of the present disclosure may proceed to provide responsive optimization in a number of ways. Accordingly, various processes in accordance with the present disclosure are described herein. Each method or process described herein may include any number of operational blocks defining the process and/or a portion thereof. It should be appreciated that in some embodiments the various processes and/or sub-processes described herein may be combined in any manner, such that the embodiment is configured to perform one or more aspects of the various processes in combination, in parallel and/or serially. In some embodiments, at least one additional and/or at least one alternative operation is performed in one or more of the described processes, and/or at least one operation is removed from one or more of the described processes.

Additionally, optional operations may be depicted in the processes utilizing dashed (or “broken”) lines. In this regard, it should be appreciated that the processes described herein are examples only and the scope of the disclosure is not limited to the exact operations depicted and described, and the depicted and described operations should not limit the scope and spirit of the embodiments described herein and covered in the appended claims.

Embodiments herein relate to and may include implementation details that can be further understood with reference to commonly-owned U.S. application Ser. No. 18/665,423, titled “SYSTEM AND METHOD OF ENHANCED MODEL INTERACTION INTEGRATION WITH IN A WEBSITE BUILDING SYSTEM,” filed May 15, 2024, which claims the benefit of U.S. Provisional Application Ser. No. 63/502,306, titled “SYSTEM AND METHOD FOR INTELLIGENT WEBSITE CREATION,” filed May 15, 2023, the entire contents of both of which are incorporated herein by reference for all purposes.

### Overview

Embodiments herein are directed to providing optimized responsive websites that are renderable across multiple display sizes and types of computing devices. Because website users are driven by experiences, editing users seek to build website designs that are responsive across all devices. Embodiments herein provide for responsive design to create websites and web applications that adapt and adjust their layout and content presentation based on a device's screen size and orientation. This ensures optimal user experience across various devices (e.g., laptops, smartphones, tablets, and desktop computers). Embodiments herein transform websites to dynamically rearrange and resize elements on a webpage to fit specific screen dimensions, providing a consistent and user-friendly interface. Transforming webpages or websites according to embodiments herein may involve not only resizing text and images but also repositioning elements and adjusting layouts to suit a specific screen width (or length or orientation).

A breakpoint is a designed width that is used in a webpage style to make the content and design of the webpage responsive, which helps enhance user experience by delivering a consistent experience across different devices. That is, a breakpoint is a point at which a website's content and design will adapt in a certain way to provide the intended user experience-breakpoints help render a webpage uniformly across different screen sizes.

Using a website building system (WBS), editing users (e.g., users generating or editing websites) can place website elements (e.g., website building tools or components) on intended webpages. However, without an appropriately equipped layout tool, a resulting design of a webpage may be non-responsive or, in other words, may not respond with changes in rendering based on the display within which the webpage is to be rendered. For example, editing users who use drag and drop techniques to place elements within an interaction user interface (e.g., a user interface with which the editing user can interact to build a webpage), without utilizing layout tools (e.g., grid or flexbox), inherently fail to create responsive designs that work well across various screen sizes. This is because placing elements without layout tools can result in overlapping elements and other issues caused by the editing user not having a sophisticated understanding of layout and breakpoints. The editing users thus expect the webpage design at lower screen sizes to be automatically adjusted to that lower screen size, or at least have a proper layout, or one that requires minimum tweaks to function properly. Without the appropriate understanding and/or tools, the webpage design will not be automatically adjusted to a lower screen size (or other change in display parameter).

Embodiments of the present disclosure overcome the aforementioned drawbacks and more by automatically transforming static website designs created by editing users into fully optimized responsive design variations that can be applied while preserving the original design intents of the editing user. Embodiments therefore boost the website creation process, shorten its duration, and additionally allow unprofessional users to perform and build advanced responsive sites that render correctly on different screen sizes (e.g., according to breakpoints). Embodiments herein significantly reduce the amount of manual effort needed for the design and development of a website that looks well across a variety of screen sizes; embodiments also remove the need for domain specific knowledge for turning website designs into responsive ones (e.g., allowing non-professional users to build fully responsive sites, much quicker and easier).

Embodiments of the present disclosure provide for arranging a new layout automatically inside sections and containers in websites assembled using a WBS across screen sizes to support responsive design, and for automatic layout and grouping of elements in a WBS based on their size, position, text semantics, media semantics, list detection, hierarchy, relation to each other, and more.

Embodiments herein leverage learning algorithms, a large corpus of historical data (e.g., website editing interaction data, website interaction data, etc.), user feedback to fine tune the learning algorithms. The user feedback is collected with respect to various design decisions of the system (e.g., groups, semantics, responsive behavior alternatives, etc.), and provides for editing users to override the automatic decisions, which allows the system to learn from the applied changes associated with the user feedback.

Embodiments provide for setting and adjusting the responsive behavior of a website design to correct a website document or structure, such as the document object model (DOM) hierarchy or internal structure, for seamless design throughout all screen sizes. Embodiments of the present disclosure iterate through website pages, or individual sections, gaining an understanding the relation between elements and their hierarchical structure, in order to place elements into groups in a recurring manner. Content elements such as text elements and image elements may be enriched with semantics based on, for example, the structure, layout, and style of the webpage, properties of the elements, editing user intent, information associated with the website, editing history of the website, and more. Groups may be enriched with structural semantics such as repeating patterns, a menu, form, and more based on the structure, layout, and style of the webpage, properties of the elements, editing user intent, information associated with the website, editing history of the website, and more The enrichment may be implemented based on existing information, such as component or structure properties, that is stored by the WBS, including historical accumulated information (e.g., editing user interactions and/or end-user usage/viewing history).

In embodiments, groups and semantics enable automatic optimization of the structure of the page and set the desired responsive behavior and layouts. Automatic layout of an entire website as well as specific sections within a webpage is supported by embodiments herein.

Embodiments of the present disclosure support both interactive mode and a fully automatic mode of operation. In the interactive mode, the editing user can specify intent and preferences, for example, following the style of a target webpage. In the fully automatic mode, the system adjusts the responsive behavior and adjusts the website automatically. In both modes, the editing user can provide feedback regarding the various decisions made by the system (e.g., also referred to as decision points). For example, the editing user may override the default responsive behavior (“keep properties”), and/or select and optimize the suggested page alternatives at the various screen sizes. Notably the system may allow the user to select different behavior or alternatives for the different screen sizes.

Embodiments herein leverage learning mechanisms to tune mobile practices to derive professional layout alternatives for website designs. For example, embodiments herein may tune the ordering at which to apply the lower breakpoints practices. Tuning this ordering may include identifying the respective importance of various elements in the composition of the webpage, such as call-to-action elements like buttons, main title, main media, and more, and giving priority in terms of positioning based on the same to the different elements. Embodiments herein may tune practices based on historically learned practices that may be applied given various aspects or metadata of a webpage. Embodiments herein my tune the parameters of the lower breakpoints, e.g., the amount of padding needed, the scaling behavior of images, the sizing of text and button components, the overall packing of the webpage (e.g., its height, width, and amount of “free space”), and more.

Embodiments herein may be implemented using one or more of a machine learning-based approach (e.g., where the tuning is driven by website editing interaction and website interaction data) or integer programming approaches that aim to optimize multiple objectives that capture layout aesthetics (e.g., alignment, “free space”, padding, and more).

Embodiments herein provide for technical improvements related to website design by ensuring a website's content and layout automatically adjust to ensure readability and usability on different devices based on executable code inserted by the system signaling to an executing browser where certain design changes should become active when rendering a webpage or website. The disclosure herein provides for a particular manner of presenting information in electronic devices such that the intended visual elements are rendered within a display window of an electronic device regardless of the screen parameters (size, height, width, etc.) of the electronic device. This particular manner eliminates the need for users of users (e.g., end users accessing the webpage or website) to unnecessarily scroll to arrive at desired visual elements or functionality, increasing usability of the electronic device. It also eliminates situations where the intended visual elements render improperly, which leads to lack of usability of the browser and consumption of the intended visual elements. The disclosure also provides for a particular manner of enabling editing users (e.g., users assembling a website using a website building system) to present the information, especially when the editing users are more novice, such that the intended visual elements are rendered within a display window of an electronic device regardless of the screen parameters (size, height, width, etc.) of the electronic device. This eliminates the need for the editing users to understand and/or implement complex practices associated with breakpoints and designing of responsive websites.

### Example Architecture and Embodiments

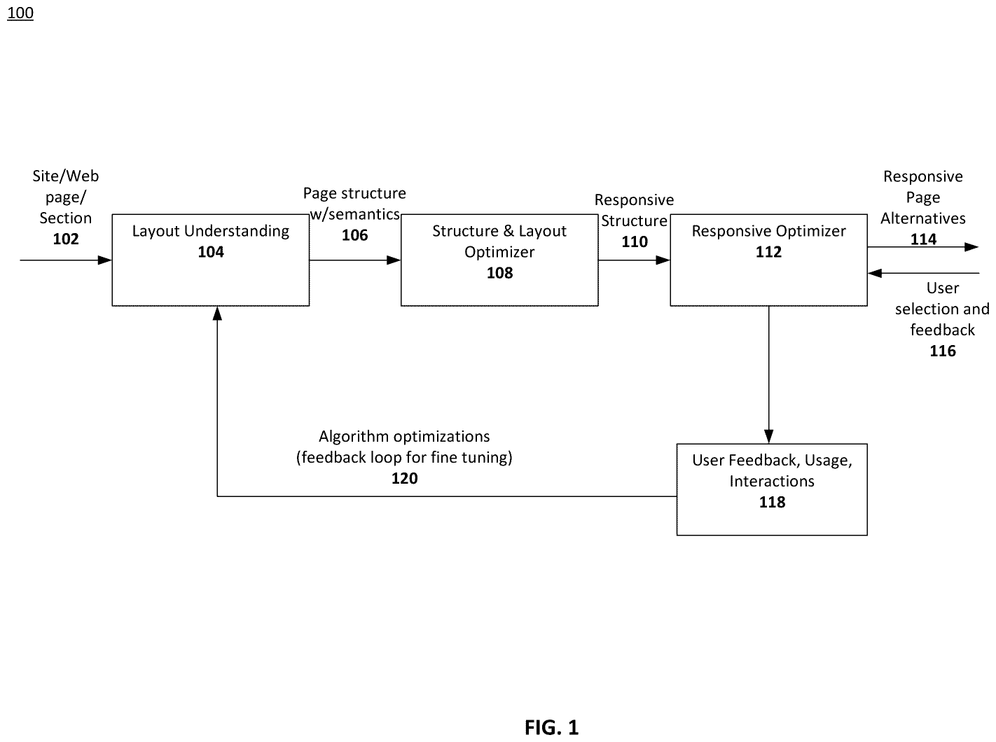

FIG. 1 illustrates an example system architecture 100 within which embodiments of the present disclosure may operate. Shown in FIG. 1, the example system architecture 100 may include a layout understanding module or model 104 that takes as input 102 a website, a webpage, a section of a webpage, and the like. The layout understanding module or model 104 may be configured to infer a hierarchical structure of the input 102 (e.g., its grouping structure) as well as semantics of groups (e.g., list, menu, etc.) and the semantics of individual components (e.g., main title, foreground image, etc.). The layout understanding module or model 104 may be configured to assign a confidence score for the predicted semantics of the groups and components; confidence scores may allow a system designer to make informed decisions regarding layouts (e.g., whether to allow a user to override the inferred groups or not). The layout understanding module or model 104 may be periodically updated to incorporate new layouts found on user websites within or known to the website building system (WBS). The layout understanding module or model 104 may also use additional analysis and grouping techniques, such as the ones described in U.S. Pat. No. 10,176,154, the entire contents of which are incorporated herein by reference.

Also shown in FIG. 1, the example system architecture 100 may include a structure and layout optimizer 108 (e.g., which may include a module and/or a model) that takes as input 106 the page structure and semantics that were output by the layout understanding module or model 104. This structure and layout optimizer 108 generates a responsive structure 110 based on the inputs 106 (e.g., the webpage, its grouping hierarchy, the semantics of groups and components, the confidence scores, and a design intent or preferences of the user). The output of the structure and layout optimizer 108 may be one or more possible responsive structures 110. To generate the one or more possible responsive structures 108, the structure and layout optimizer 108 applies various layout techniques (e.g., also referred to herein as layout tools) to the webpage such as grouping elements with a repeating pattern into a repeater-style container, stacking elements arranged horizontally or vertically into a flex container, or placing groups that are laid out in a 2-dimensional layout in a div (e.g., an example grid container) with cascading style sheets (CSS) grid layout. CSS is a stylesheet language that may be used to describe the presentation of a document written in HTML or XML (including XML dialects such as SVG, MathML or XHTML). CSS may describe how elements may be rendered on screen, on paper, in speech, or on other media.

Also shown in FIG. 1, the example system architecture 100 may include a responsive optimizer 112 that takes as input the one or more responsive structures 110 output by the structure and layout optimizer 108. The responsive optimizer 112 (e.g., module and/or model) may be configured to adapt a webpage to render appropriately on a variety of screen sizes and generate new responsive layouts for the given set of breakpoints. The responsive optimizer 112 generates and outputs one or more responsive page alternatives 114, each comprising an adapted webpage representation with optimized structure, style, and layout that renders appropriately at the target breakpoints. The responsive page alternatives 114 are generated based on the one or more responsive structures 110, the user intent, design guidelines, and any user feedback 116 (e.g., provided by way of electronic interactions with a user interface). The responsive optimizer 112 may be configured to leverage various lower breakpoint design practices, such as layout modifications (e.g., for section layout, change from columns to rows, horizontal stack turns into a vertical stack), hiding elements, repositioning and reordering elements, resizing elements (e.g., section height, text, and button size), style changing (e.g., optimize fonts and colors), alignment of elements and groups of elements (e.g., center the media in mobile), spacing and gaps between elements, flex properties (e.g., wrap, scroll), and more.

Also shown in FIG. 1, the example system architecture 100 may include a user feedback module 118 that collects user feedback (e.g., 116). For example, the user feedback module 118 may be configured to collect data regarding responsive page alternatives that have been presented to editing users and whether any have been selected or modified by end users (e.g., fine tuning the suggested alternative). The user feedback module 118 can record and store this data in a repository. An example of such a user feedback system may be found in U.S. Patent Publication 2022/0197969 and U.S. Pat. No. 11,275,815, the contents of both of which are incorporated herein by reference in their entirety.

The user feedback module 118 may be configured to support continuous optimization 120 of the algorithms, modules, or models herein (e.g., closed feedback loop, see above) based on user feedback, interactions, and usage data.

### Example Operations Associated with Embodiments Herein

Embodiments herein relate to automatically transforming static designs into fully optimized responsive design variations that can be applied while preserving the original design intents of the editing user. Responsive website designs render appropriately regardless of screen parameters associated with an electronic device on which the website is to be displayed.

### Overall Responsive Optimization

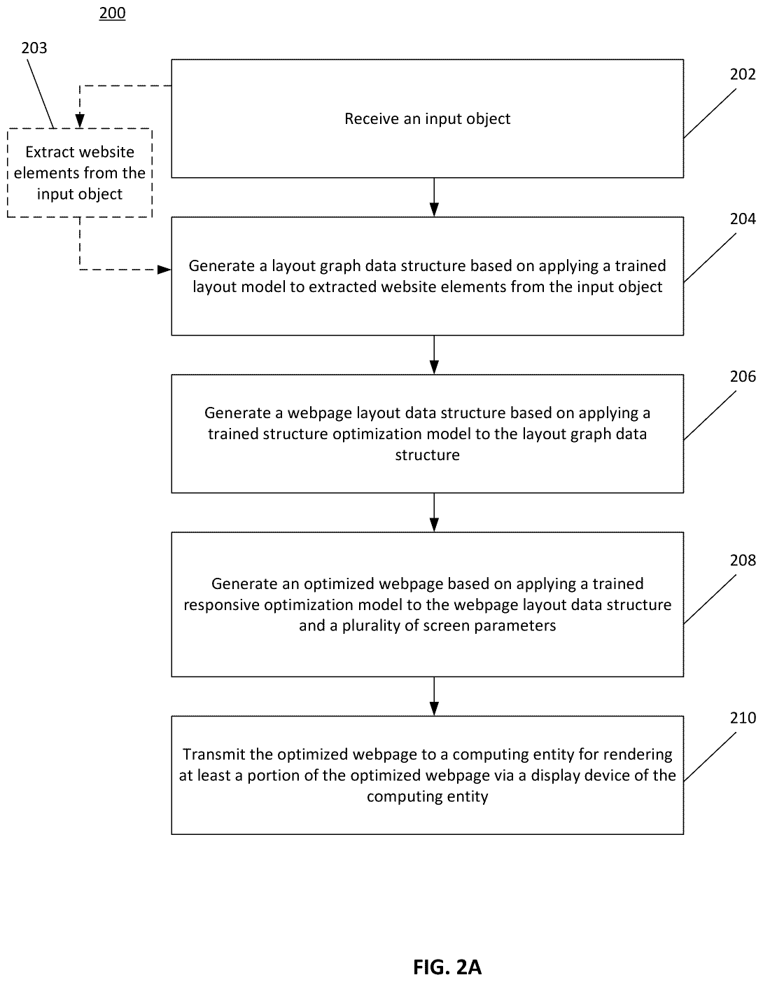

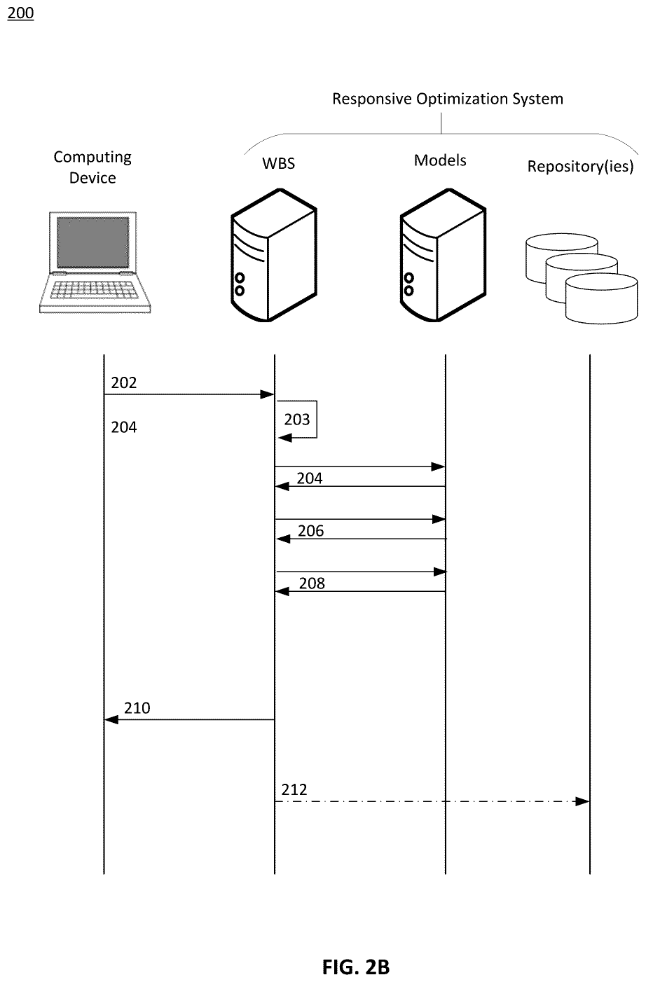

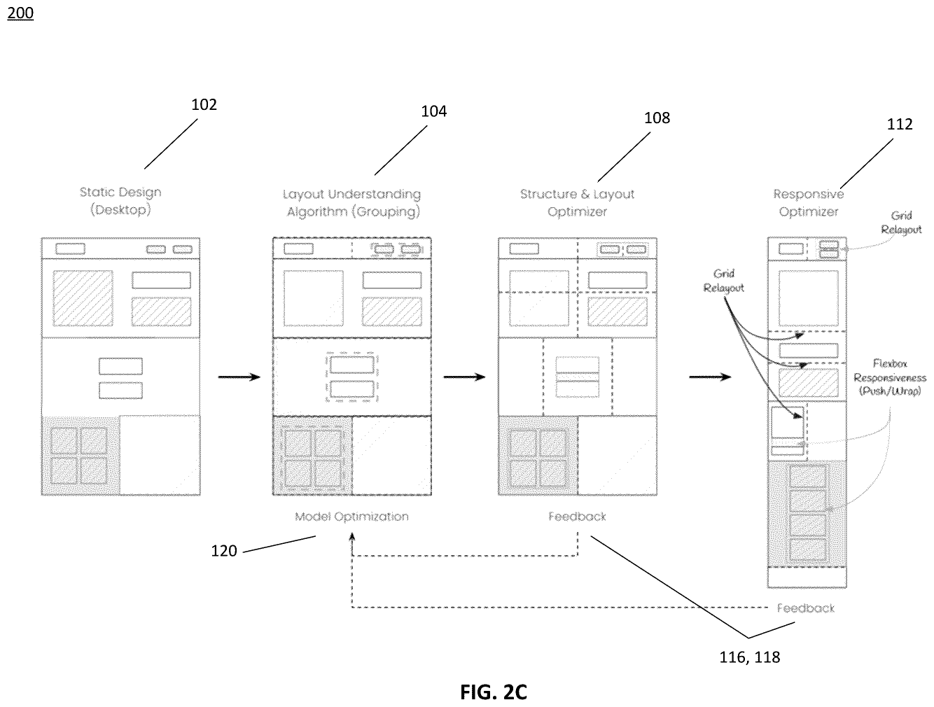

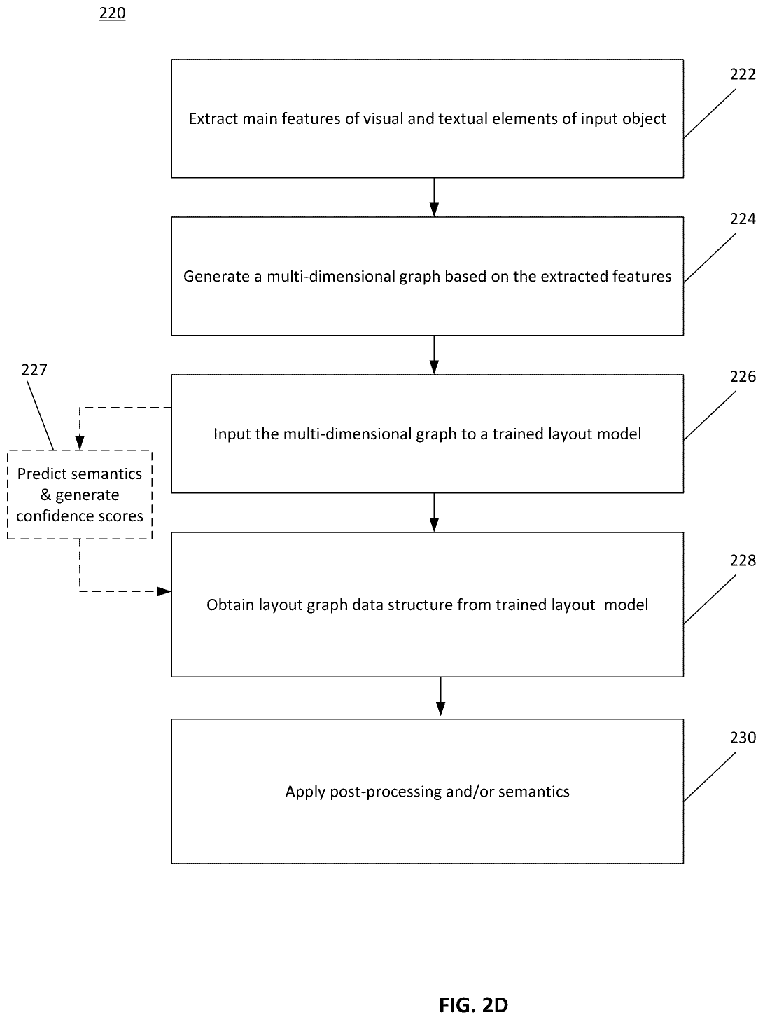

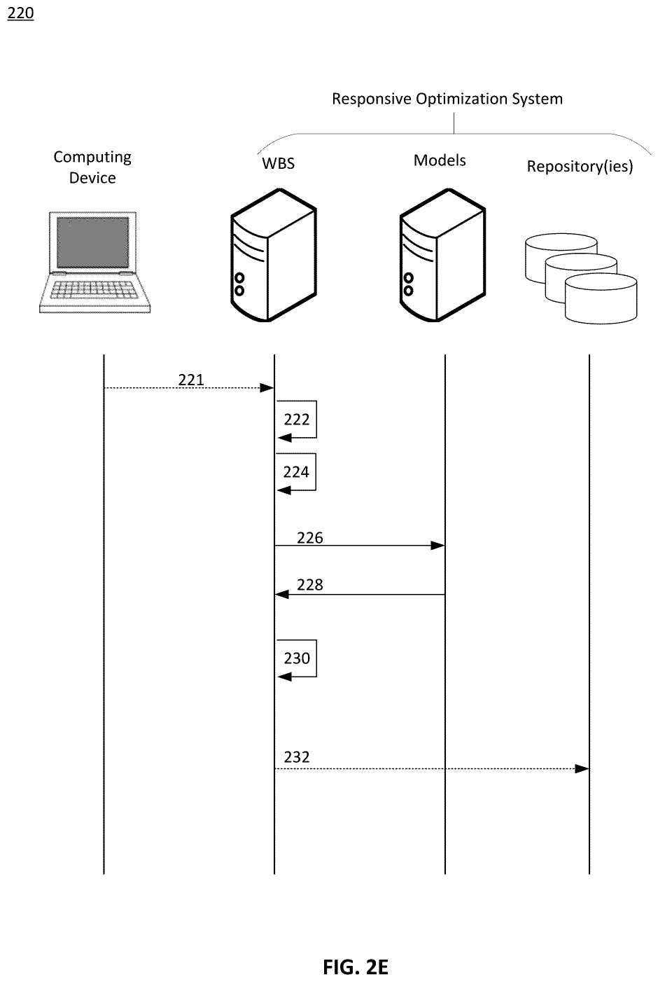

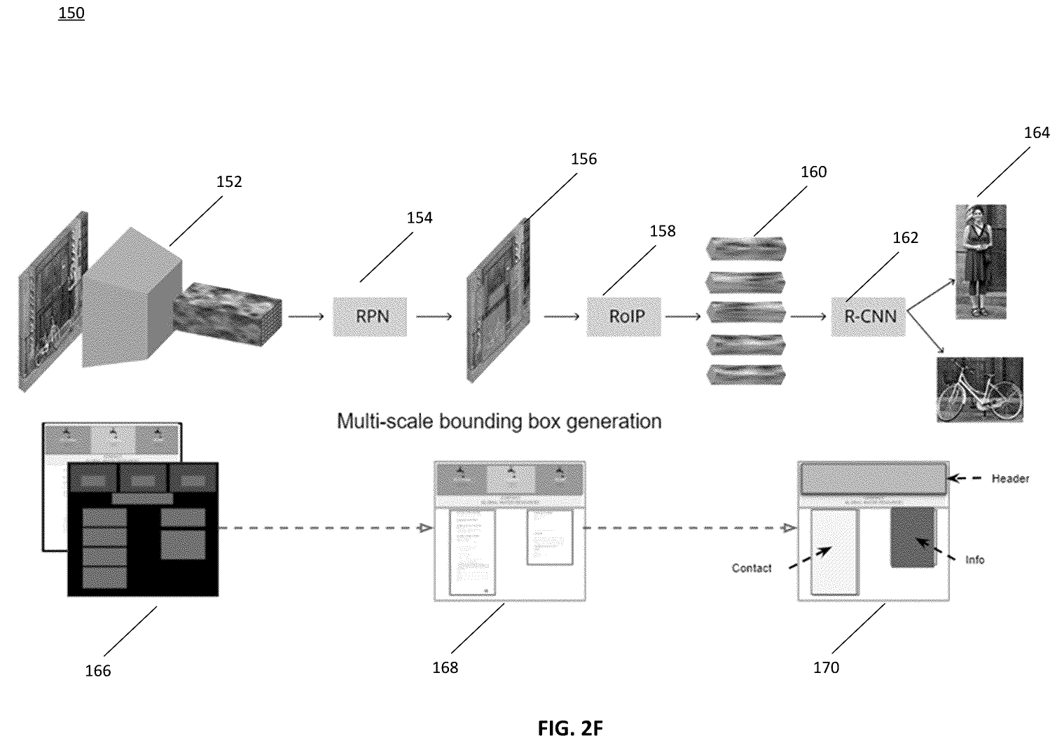

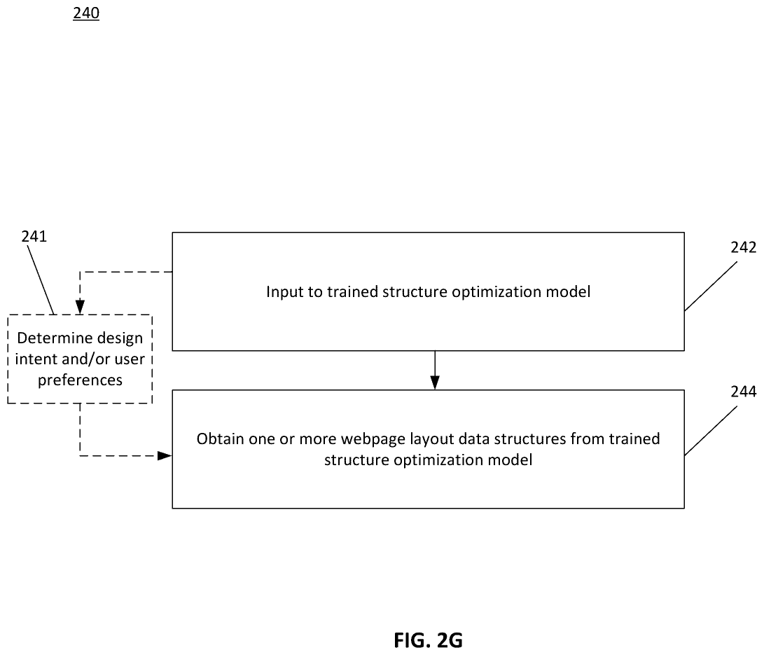

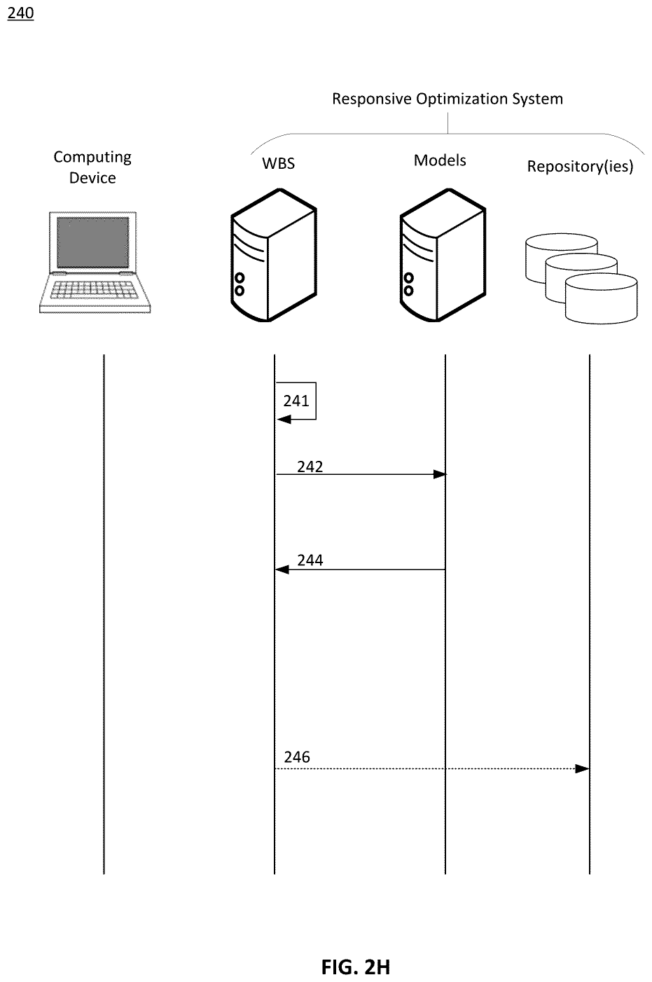

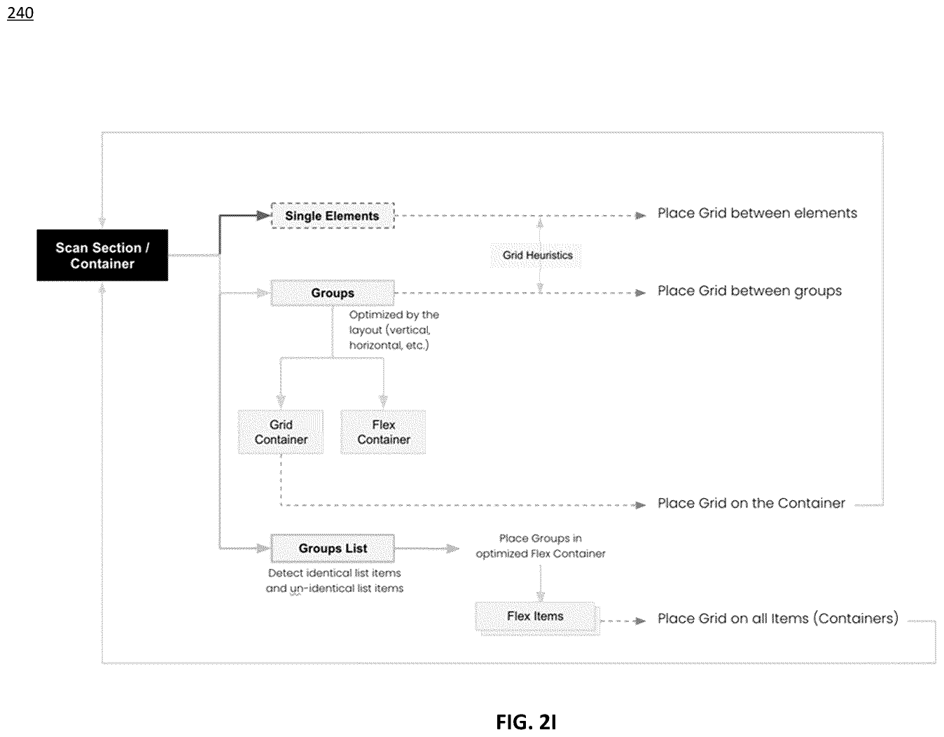

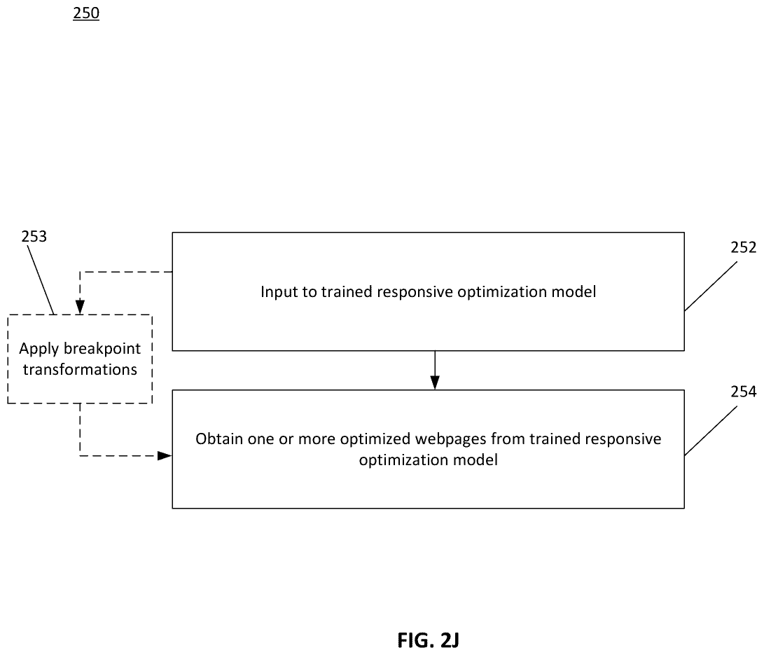

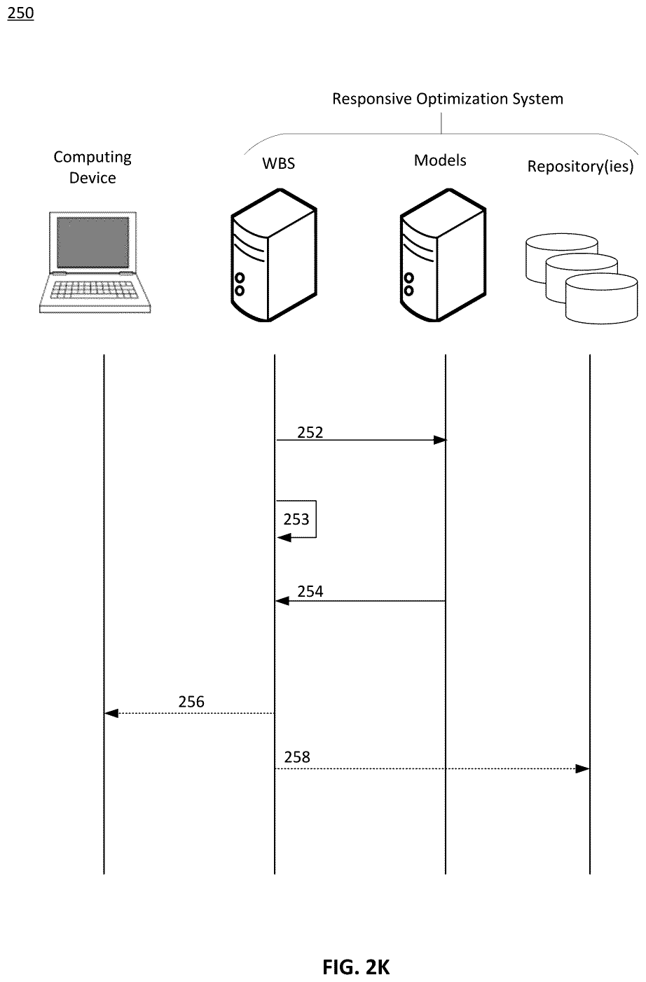

FIGS. 2A and 2B depict example operations associated with generating optimized responsive website designs in accordance with some example embodiments described herein. The operations illustrated in FIGS. 2A and 2B may, for example, be performed by an RO server 1812, which may include means, such as memory 2102, processor 2104, input/output module 2106, communications module 2108, RO module 2110, and/or the like, which are collectively configured for responsive optimization. The operations may further be performed by one or more client devices 1808A-N, which may include means, such as memory 2202, processor 2204, input/output module 2206, communications module 2208, and/or the like.

In some embodiments, shown in FIGS. 2A and 2B, at step/operation 202, the process 200 includes receiving an input object. The input object may include one or more website building tools. In some embodiments, the one or more website building tools may include pages, sub-pages, containers, components, atomic components, content elements, layout elements, templates, layouts, layout rules, add-on applications, third-party applications, procedural code, or application programming interfaces.

In some embodiments, the input object may include historical website editing interactions associated with a website editing user identifier associated with the input object or a plurality of website editing users associated with a website building system with which the website editing use is associated. The input object may include an input file. The input object may include interactions associated with an editing user associated with the website editing user identifier interacting with extracted website elements prior to extraction from the one or more website building tools. The input object may include content (e.g., text, images, other content), semantic features (e.g., semantic-related enhancements to one or more components) or contextual features (e.g., context-related enhancements to one or more components) associated with the one or more website building tools.

In some embodiments, shown in FIGS. 2A and 2B, at step/operation 204, the process 200 includes generating a layout graph data structure based on applying a trained layout model to extracted (203) website elements from the input object. That is, the extracted website elements (or the input object) may be input to the trained layout model and the layout graph data structure may be obtained from the trained layout model.

In some embodiments, shown in FIGS. 2A and 2B, at step/operation 206, the process 200 includes generating a webpage layout data structure based on applying a trained structure optimization model to the layout graph data structure. That is, the layout graph data structure may be input to the trained structure optimization model, and the webpage layout data structure may be obtained from the trained structure optimization model.

In some embodiments, shown in FIGS. 2A and 2B, at step/operation 208, the process 200 includes generating an optimized webpage based on applying a trained responsive optimization model to the webpage layout data structure and a plurality of screen parameters. That is, the webpage layout data structure and a plurality of screen parameters may be input to the trained responsive optimization model and the optimized webpage may be obtained from the trained responsive optimization model. The optimized webpage is configured to render according to the plurality of screen parameters, which may include various screen dimensions across several electronic device displays (e.g., the webpage includes executable code such that design or other aspects of the webpage will automatically change or adjust according to screen parameters of an electronic device when the webpage is rendered via a browser associated with the screen parameters of the electronic device).

In some embodiments, shown in FIGS. 2A and 2B, at step/operation 210, the process 200 includes transmitting, to a client computing device, the optimized webpage for rendering at least a portion of the optimized webpage via a display device of the client computing device.

It will be appreciated that, while embodiments herein are described with respect to transmitting interfaces to a client computing entity and receiving interface interactions from the client computing entity, such that implementations may be referred to client-side rendering implementations, embodiments herein apply to and support server-side rendering without departing from the scope of the present disclosure. Embodiments herein also apply to implementations involving a combination of client-side and server-side rendering. Thus, the referenced client computing entity may also include element performed on a server (including but not limited to cloud and server-farm instances and virtual servers or other execution instances).

In various embodiments, an environment within which embodiments herein operate may be front-end (e.g., in client-side rendering), back-end (e.g., in server-side rendering), or a combination thereof. One or more website interface rendering modules may form part of server-side software executed by a server. While various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

In various embodiments, the environment may be a browser window, thread, or any server-side technology used to one or more parts of a webpage. In a further example, it is contemplated by this disclosure that some or all of the functionality of website interface rendering may optionally be performed by a client-side software application running on one or more client devices and the disclosure is not limited to the specifically identified arrangement of software executed herein. For example, when rendering on the server-side, an environment may be operating on the device, platform, or software used for rendering the page content (HTML, CSS or otherwise) to be sent to the browser (or another user agent). Moreover, in some embodiments, a server providing one or more execution environments may be performed on a separate server.

Interactions associated with process 200, including input from editing users and/or feedback associated with alternatives presented to editing users, may be collected and stored 212 in one or more repositories for fine tuning one or more of the models described herein.

FIG. 2C depicts an operational example of providing responsive optimization in accordance with embodiments herein. Shown in FIG. 2C, a static design (e.g., input object 102, represented as a schematic design or a wireframe with groups and grids) may be input to a trained layout understand model or module 104, the output of which may be input to a structure and layout optimization module 108. The output of the structure and layout optimization module 108 may be input to a responsive optimizer 112. Feedback 116 may be collected and stored by a user feedback module 118 for model optimization 120. FIG. 2C illustrates cascaded trained models leveraged to form an end-to-end solution that transforms a static design into a responsive one. The cascaded trained models provide flexible user controllability through feedback input, allowing users to override the default responsive behavior of the system, select design alternatives, and customize behavior for different screen sizes.

### Layout Understanding

FIGS. 2D and 2E depict example operations 220 associated with layout understanding in accordance with embodiments herein. The operations illustrated in FIGS. 2D and 2E may, for example, be performed by an RO server 1812, which may include means, such as memory 2102, processor 2104, input/output module 2106, communications module 2108, RO module 2110, and/or the like, which are collectively configured for responsive optimization. The operations may further be performed by one or more client devices 1808A-N, which may include means, such as memory 2202, processor 2204, input/output module 2206, communications module 2208, and/or the like.

Embodiments herein employ a layout understanding model or module (e.g., 104) to automatically infer a grouping from a layout (among other aspects) of a webpage (e.g., or section of a webpage) or input file. Grouping benefits many use cases in graphic design; grouping makes it easier for users to manage related visual elements by allowing them to perform actions on a group of elements at once. Despite being useful, many webpages lack explicit annotations for their hierarchical grouping.

Existing techniques for layout understanding in graphic design applications and specifically for webpages develop aesthetic and other rules (e.g., spatial, perceptual, and importance-based to name a few) to group visual components. Other existing techniques apply heuristics that leverage the HTML structure to group DOM elements in a webpage. These techniques often achieve limited quality due to the large variety of layout patterns in webpages. To address these limitations, some existing layout understanding techniques use image processing, applied on a rendered webpage (e.g., the webpage's screenshot), to derive groupings. Other techniques employ machine learning approaches that use pixel-based group detection—these techniques use robust vision-based object detection techniques to infer the grouping, where the training is done using a large dataset of webpages, user interface (UI) designs (e.g., from various apps), and screenshots.

Embodiments herein overcome drawbacks associated with existing techniques and more by using a learning-based approach with main features of visual elements as inputs (e.g., as opposed to screenshots). By using a much simpler representation, embodiments herein avoid the need for fully rendering the webpage, a costly operation, to determine grouping. Further, having simpler input features reduces the dataset size requirement compared to an image-based grouping. This, in turn, provides for an efficient solution geared for interactive or real-time graphical design workflows.

Layout understanding according to embodiments herein includes generating a schematic image that represents the webpage, also called a wire frame image (e.g., and/or a multi-dimensional graph structure), where each element type may be color-coded differently. For text elements, a pattern can be created within the corresponding bounding box that captures its text attributes. The pattern can be a repeating character, a smooth repeating pattern (e.g., a sine wave), some shading, or some other visual effect that is unique for text components in the wireframe representation. A vision-based object detection algorithm may be applied to compute pixel-level (bounding box) candidates for groups and their types, e.g., list, menu, stackable, etc. Post-processing may be applied on the bounding boxes to create the resulting tree hierarchy structure (e.g., layout graph data structure) that represents the elements in the webpage.

In some embodiments, shown in FIGS. 2D and 2E, at step/operation 222, a process 220 includes extracting features a received (221) input data object. The features may include features of visual and textual elements, content of the input data object (e.g., images, names, other content), and more. That is, the input to the trained layout model is generated by extracting features of the visual elements, which may include, for example, element type, z-index, position, and size, and of the textual elements, which may include, for example, font size, font type, and character count. Extracting the features may include taking into account an existing hierarchy of elements on the webpage if one is available and arranging the input elements in a tree structure. This allows for the capture of, for example, a container element that encapsulates several text elements. By way of further example, extracting features of the input data object may involve detecting that a person's name is part of the content, or that an image or picture is present in the content. The features may be associated with metadata as well as contextual data—and/or may inform the generation or inference of metadata and/or contextual data.

In some embodiments, shown in FIGS. 2D and 2E, at step/operation 224, the process 220 includes generating a multi-dimensional graph, based on the extracted features, comprising a plurality of nodes and a plurality of edges. An edge of the plurality of edges may represent a relationship between two or more nodes of the plurality of nodes. A node represents a visual element of the elements of the webpage and an edge represents a containment relationship between two or more visual elements. A node of the plurality of nodes is associated with a node identifier, a node index, an element size, an element position, textual attributes, and children node identifiers. In some embodiments, an edge may further represent one or more of an anchor, an explicit anchor, an automatic anchor, a semi-automatic anchor, or a gate condition.

For example, in some embodiments, anchors may define (or inform) relationships between website elements and their content. Still further, in accordance with a preferred embodiment of the present invention, the anchors define the relationships between the parallel edges of adjacent website elements along a primary direction. Anchors may define (or inform) the relationships between edges (not necessarily to be confused with edges of the aforementioned multi-dimensional graph) of the website elements with a matching edge of a secondary website element. An anchor may be associated with information such as the anchor information, the anchor creation history, the original position and size of the elements and designer and end-user parameters. Dynamic layout may involve the moving and resizing of components on the screen rendering a website based on dynamic layout triggers. Some examples may include the use of anchoring and docking the controls in a graphical user interface (GUI) design. Anchoring may entails connecting an edge (again, not to be confused with the edges of the aforementioned multi-dimensional graph) of a GUI component to the edge of a container, causing the component to be resized or moved when the container changes. Docking may entail specifying that multiple GUI components are stacked (based on predefined priority) near a given edge of a container.

An explicit anchor may be an anchor specified by a designer such that explicit anchors may remain until removed by the designer. An automatic anchor may be an anchor generated by a website building system (WBS) according to one or more automatic anchoring rules. A semi-automatic anchor may be an anchor suggested by a WBS and confirmed by a designer. A gate condition may be per-component/per-edge attributes for one or more automatic anchoring rules which specify if a given rule would be applied to a given component edge or not. Anchoring and dynamic layout techniques for use with embodiments herein may be further understood with reference to commonly-owned U.S. Pat. No. 10,185,703, entitled “WEB SITE DESIGN SYSTEM INTEGRATING DYNAMIC LAYOUT AND DYNAMIC CONTENT,” which is incorporated by reference herein in its entirety.

In some embodiments, shown in FIGS. 2D and 2E, at step/operation 226, the process 220 includes inputting the multi-dimensional graph to the trained layout model. In some embodiments, the trained layout model includes a neural network and is configured to generate the layout graph data structure based on inferring a hierarchical structure of a webpage associated with the input object.

In some embodiments, shown in FIGS. 2D and 2E, at step/operation 228, the process 220 includes obtaining a layout graph data structure from the trained layout model (e.g., as output from the trained layout model). In some embodiments the layout graph data structure represents the hierarchical structure of a webpage associated with the input object and includes elements of the webpage, relationships between the elements of the webpage, and semantics associated with the elements of the webpage.

In some embodiments, the layout graph data structure is a tree structure comprising a plurality of nodes and a plurality of edges, where each node may represent an element or a group of elements. Nodes representing individual elements may be located at the leaves of the tree structure while node representing groups of elements may be located at internal nodes of the tree structure. The children of a group node may be those elements or groups that are contained (visually) within it.

In some embodiments, the trained layout model is configured to traverse the layout graph data structure to generate, for each group node e, (1) a group type (e.g., list, menu, stackable container, etc.) and (2) a likelihood of correct group type prediction pₑ, where 0≤pₑ≤1.

In some embodiments, the trained layout model is further configured to generate the layout graph data structure based on predicting (227) semantics associated with groups and structural elements of the hierarchical structure of the webpage and generating a confidence score for a semantic prediction associated with a group or structural element of the hierarchical structure of the webpage. That is, the trained layout model may be configured to group structural elements of the webpage based on predicted semantics associated with the structural elements and predict semantics of the resulting groups of structural elements. The trained layout model may be further configured to apply vision-based object detection to compute pixel-level candidates of visual elements for inclusion in a group of structural elements. The trained layout model may be further configured to generate a pattern to capture text attributes of a text element.

In some embodiments, shown in FIGS. 2D and 2E, at step/operation 230, the process 220 includes applying post-processing to the layout graph data structure. In some embodiments, post-processing includes applying bounding boxes to create a resulting layout graph data structure.

In some embodiments, the trained layout model may be configured to group structural elements of the webpage based on predicted semantics associated with the structural elements and predict semantics of the resulting groups of structural elements. The trained layout model may be further configured to apply vision-based object detection to compute pixel-level candidates of visual elements for inclusion in a group of structural elements. The trained layout model may be further configured to generate a pattern to capture text attributes of a text element.

In some embodiments, the trained layout model is trained using a data corpus of webpages, including annotations associated with the webpages (e.g., manually or auto-generated or learned), and including hierarchical grouping structure and group types.

In some embodiments, the layout graph data structure, or output of the trained layout model is augmented with text semantics, such as main title, subtitle, and more. The text semantics provide for later ordering of the elements for different breakpoints. One or more trained machine learning models may be used to compute the semantics of text elements. For training of the machine learning models, a dataset of webpages with text element semantic annotations may be used.

In some embodiments, the layout graph data structure, or output of the trained layout model is augmented with image semantics, such as background, logo, flowchart, main image (hero), and more. The image semantics provide for later ordering or hiding of the elements for different breakpoints. One or more trained machine learning models (e.g., image classification) may be used to compute the semantics of images.

The layout graph data structure may be stored 232 in one or more repositories.

FIG. 2F illustrates an example architecture 150 employing a neural network for layout understanding, in accordance with embodiments herein. Example architecture 150 includes a neural network that identifies objects (groups), their hierarchy, and semantics from a schematic representation of the webpage. The example architecture 150 employs convolutional layers 152 to extract features from images, a region proposal network (RPN) 154 to identify potential object locations 156, and a region of interest pooling (RoIP) 158 to standardize 160 such regions. The example architecture 150 further uses a region-based convolutional neural network (R-CNN) 162 (fully connected layers) to classify 164 objects and find their locations and sizes (166, 168, 170). In this example, objects are groups with associated semantics (e.g., header, contact, info, list, and more).

### Structure Optimization

FIGS. 2G and 2H depict example operations associated with structure optimization in accordance with embodiments herein. The operations illustrated in FIGS. 2G and 2H may, for example, be performed by an RO server 1812, which may include means, such as memory 2102, processor 2104, input/output module 2106, communications module 2108, RO module 2110, and/or the like, which are collectively configured for responsive optimization. The operations may further be performed by one or more client devices 1808A-N, which may include means, such as memory 2202, processor 2204, input/output module 2206, communications module 2208, and/or the like.

In embodiments, structure optimization includes using inputs such as a webpage, the grouping hierarchy, semantics of groups and components, confidence scores, and design intent or preferences of the user to decide which layout techniques to apply to the webpage. The output (and goal) of structure optimization is an appropriate layout structure for the page.

In some embodiments, structure optimization herein includes employing one or more layout techniques. Examples of layout techniques that may be used include (but are not limited to):
Grouping elements with a repeating pattern into a repeater-style container. If a repeating pattern is recognized (same item or group of items horizontally/vertically laid out twice or more) it is converted to a 2D Flexbox with the relevant elements. The recurring logic of creating groups and CSS Grid applies to the respective Flexbox items.
Stacking elements arranged horizontally or vertically into a flex container.
Placing grid containers (or simply grids) and aligning grid lines according to the composition and layout of groups.
Media elements such as an Image, Video, or Shape are placed in a separate CSS Grid cell (if the elements are not overlapping other elements) by placing a gridline on one of the element's edges. If the media is recognized as a repeating pattern (same 2 elements in a horizontal/vertical layout) it is placed in a Flexbox as a Flexbox item.

It will be appreciated that the examples above are for illustrative purposes and are mere examples of implementations. They are not intended to be limiting in any manner.

In some embodiments, shown in FIGS. 2D and 2E, at step/operation 242, a process 240 includes inputting, to a trained structure optimization model, one or more of the input object, the layout graph data structure, semantic predictions for groups and structural elements of a webpage associated with the input object, confidence scores associated with the semantic predictions, design intent of an editing user associated with the input object, and user preferences associated with the editing user. The design intent or user preferences may be determined (241) based on one or more of design or layout patterns associated with websites associated with the editing user, design system guidelines, or interactions with a user interface performed by the editing user.

In some embodiments, shown in FIGS. 2D and 2E, at step/operation 244, the process 240 includes obtaining, from the trained structure optimization model, a webpage layout data structure. In some embodiments, the trained structure optimization model is configured to apply one or more of grouping, stacking, or placement of structural elements of the webpage.

In some embodiments, the trained structure optimization model is configured to generate and output multiple variations of a webpage layout data structure by varying parameters of applied layout techniques. FIG. 21 depicts an operation example of structure optimization in accordance with embodiments herein.

The webpage layout data structure may be stored 246 in one or more repositories.

The trained structure optimization model may be configured to support generating multiple layout alternatives (e.g., webpage layout data structures) by varying parameters of the layout techniques applied by the trained structure optimization model. For example, the alignment requirements (center, left, right), the order of elements within a container or a section, and more can be varied. The trained structure optimization model may be further configured to vary the types of techniques used, e.g., applying grid vs. push-and-wrap layout or behavior.

Push-and-wrap behavior refers to a layout behavior observed in responsive web design or mobile app design. Push-and-wrap behavior may be used to handle content that exceeds the available space on a screen. In push-and-wrap behavior, when the content within a container exceeds the container's width or height, instead of overflowing and causing horizontal or vertical scrollbars, the content is “pushed” and wrapped to the next line or row, adjusting the layout accordingly.

In a responsive website with a grid layout or behavior, if the content within a grid cell is too wide to fit within the cell's width, the content will push and wrap to the next row, ensuring that the overall layout remains intact. Grid behavior may be used to accommodate different screen sizes and maintain a visually pleasing and user-friendly layout. Push-and-wrap behavior helps optimize the presentation of content, making it accessible and readable without requiring users to scroll excessively. It contributes to a responsive and adaptable design that can gracefully handle varying screen sizes and orientations.

### Responsive Optimizer

FIGS. 2J and 2K depict example operations associated with responsive optimization in accordance with embodiments herein. The operations illustrated in FIGS. 2J and 2K may, for example, be performed by an RO server 1812, which may include means, such as memory 2102, processor 2104, input/output module 2106, communications module 2108, RO module 2110, and/or the like, which are collectively configured for responsive optimization. The operations may further be performed by one or more client devices 1808A-N, which may include means, such as memory 2202, processor 2204, input/output module 2206, communications module 2208, and/or the like.

In embodiments, a trained responsive optimization model may be configured to adjust a structure, style, and/or layout of a webpage based on user intent, design guidelines, and constraints like screen width. The trained responsive optimization model may be configured to apply transformations, or breakpoint design practices, such as text wrapping, element sizing, and alignment, and to adapt layouts for different screen widths (e.g., turning horizontal stacks into vertical ones for smaller screens). The output of the trained responsive optimization model is an optimized webpage that provides a seamless user experience across various devices and screen sizes.

In some embodiments, the trained responsive optimization model may be implemented using a trained machine learning model configured to be retrained using historical website editing interactions, editing user intent, website data, and system design guidelines. In some embodiments, the trained responsive optimization model may be implemented using a heuristic model (e.g., or integer programming approaches) configured to generate layouts that are optimized for lower breakpoint layouts by specifying aesthetic objectives that ensure performant and aesthetically pleasing layouts. Examples of aesthetic objectives may include component packing, alignment, grouping, and preferential placement of elements. It will be appreciated that both approaches may be extended to provide interactive diversification, enhancement, and completion of partially prepared (e.g., incomplete) designs. For example, variation of the layouts for different breakpoints can be computed by varying the parameters (e.g., elements sizing, alignment, spacing, and gaps), by adjusting the layout tools (e.g., applying flex properties such as scroll), by injecting content (e.g., texts and media), and/or by adapting the style (e.g., color, typography).

In some embodiments, shown in FIGS. 2J and 2K, at step/operation 252, a process 250 includes inputting, to a trained responsive optimization model, one or more webpage layout data structures and a plurality of screen parameters. The plurality of screen parameters may include a screen width, a screen height, a screen orientation, or target breakpoints.

In some embodiments, shown in FIGS. 2J and 2K, at step/operation 254, the process 250 includes obtaining, from the trained responsive optimization model, one or more optimized webpages configured to render according to the plurality of screen parameters.

The trained responsive optimization model may apply (253) breakpoint transformations such as text wrapping, element resizing, element hiding, element repositioning, element reordering, element alignment, layout adaptation, or style changing, group alignment, space adjusting, element property adjusting, breakpoint parameter tuning, or transforming horizontal elements to vertical elements. Breakpoint parameter tuning may include tuning an amount of padding needed, tuning a scaling behavior of images, tuning a sizing of text and button components, or tuning an overall packing of the webpage.

The one or more optimized webpages may be provided (e.g., transmitted) 256 for rendering and further observation or selection, and/or may be stored 258 in one or more repositories.

### Example User Interfaces

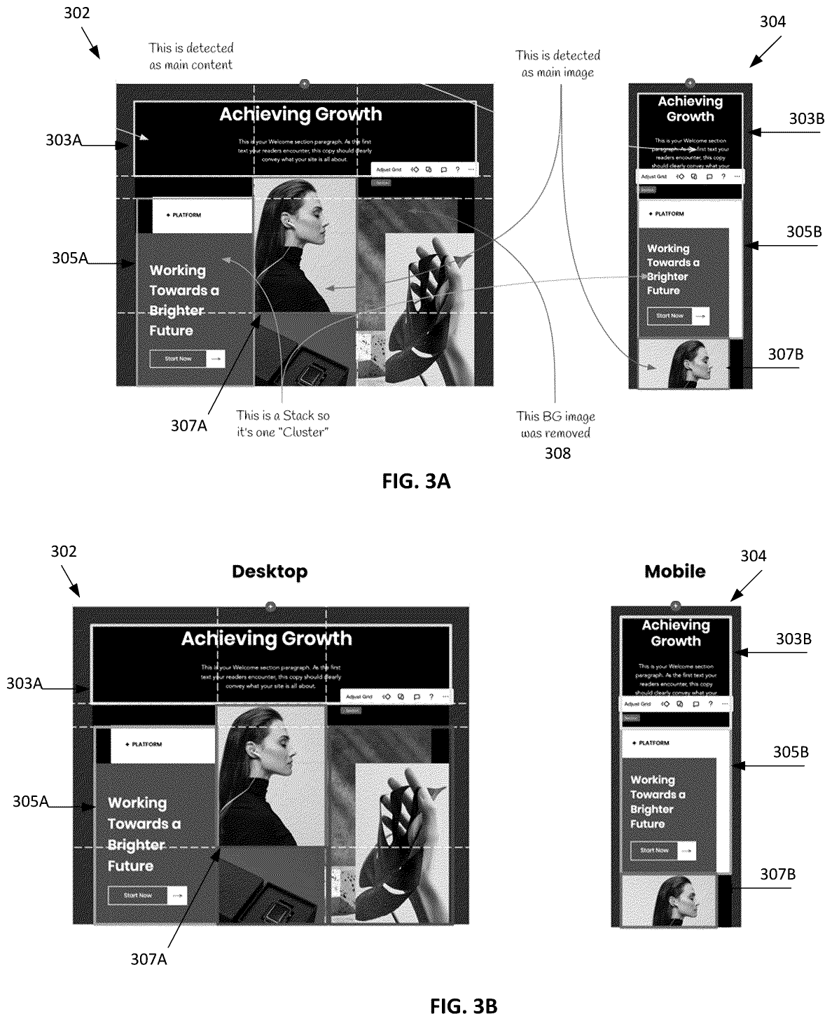

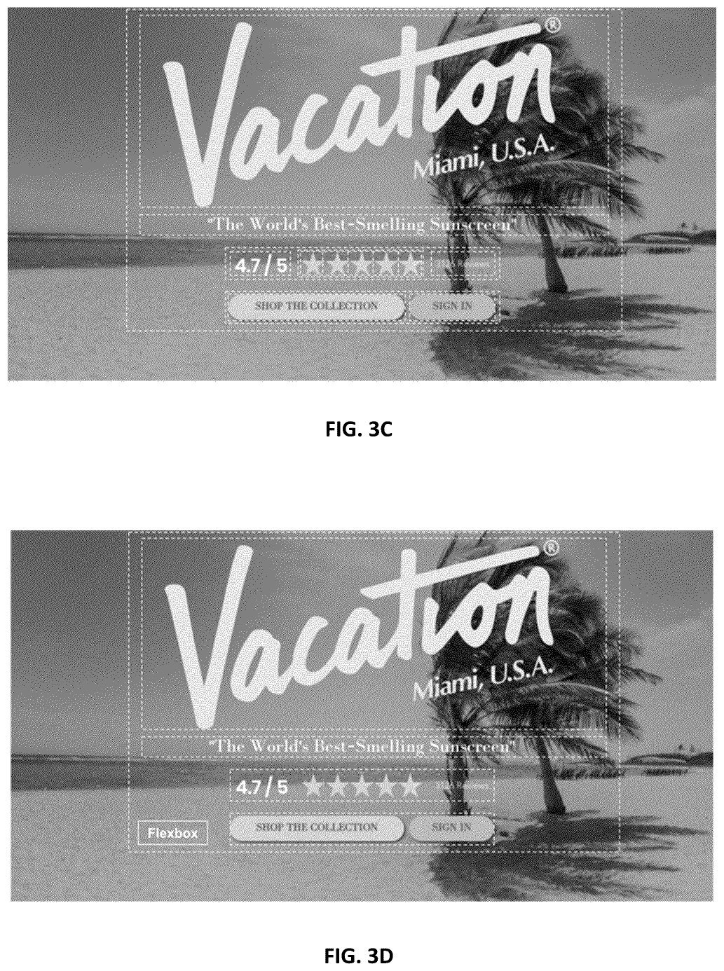

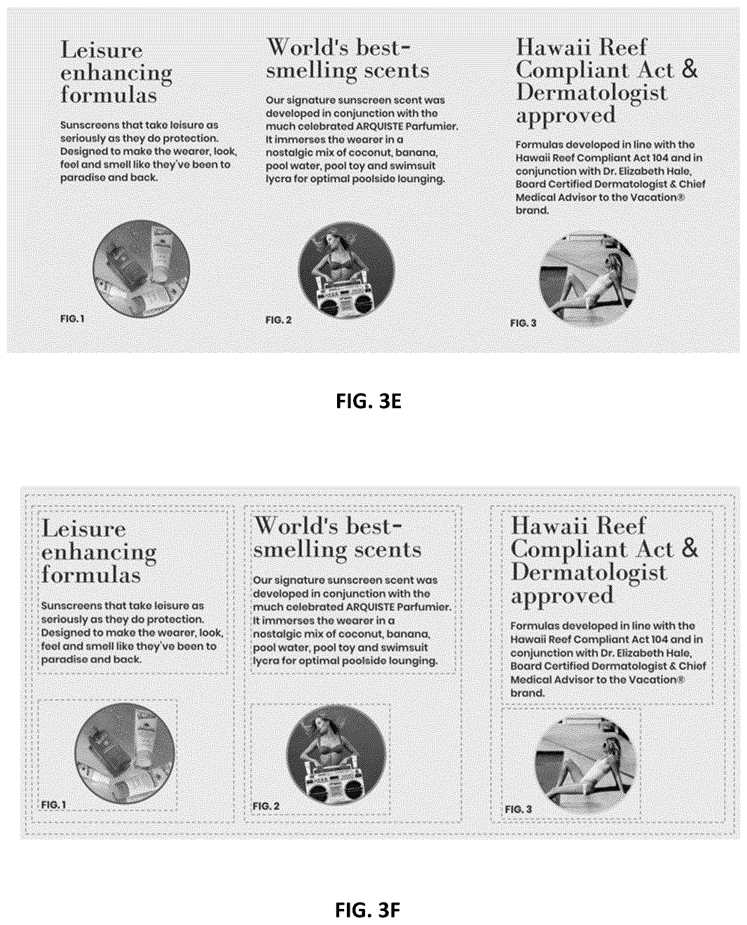

FIGS. 3A-3F depict example user interfaces in accordance with embodiments herein.

FIG. 3A depicts example operation of embodiments herein using example user interfaces. In FIG. 3A, an input data object 302 is a static website design and the output 304 (e.g., optimized webpage; mobile design) is a fully responsive design. Predictions made by embodiments herein are marked in corresponding colors. The hierarchical structure inferred by the layout understanding model (e.g., the groups) is shown as bounding boxes, and the grid placement of the structure optimization model as dashed lines. The mobile design (304) reflects the design practices applied by the responsive optimization model, such as component re-ordering and font size changes.

For example, shown in FIGS. 3A and 3B, the content of the input data object 302 identified as 303A is identified, detected, or predicted to be main content, and is reflected in the mobile design 304 as 303B (303A and 303B are both depicted, for the purposes of illustration, in FIGS. 3A and 3B with a yellow box around them). The content of the input data object 302 identified as 305A is detected, identified, or predicted to be a stack or a cluster, and is reflected in the mobile design 304 as 305B (305A and 305B are both depicted, for the purposes of illustration, in FIGS. 3A and 3B with an orange box around them). The content of the input data object 302 identified as 307A is detected, identified, or predicted to be a main image, and is reflected in the mobile design 304 as 307B (307A and 307B are both depicted, for the purposes of illustration, in FIGS. 3A and 3B with a pink box around them). The content of the input data object 302 identified as 308 is an image that was removed from (e.g., not reflected in) the mobile design 304.

FIGS. 3C and 3D demonstrate how embodiments herein apply stacking of elements arranged vertically into a flex container, having inner groups stacked horizontally. FIGS. 3E and 3F further demonstrate extraction and grouping of elements according to embodiments herein.

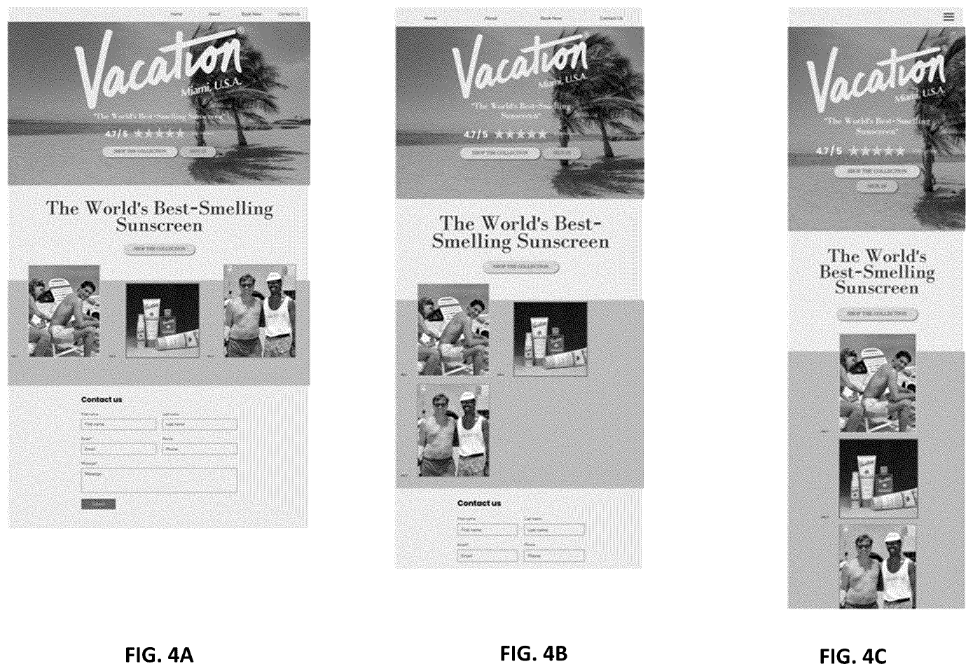

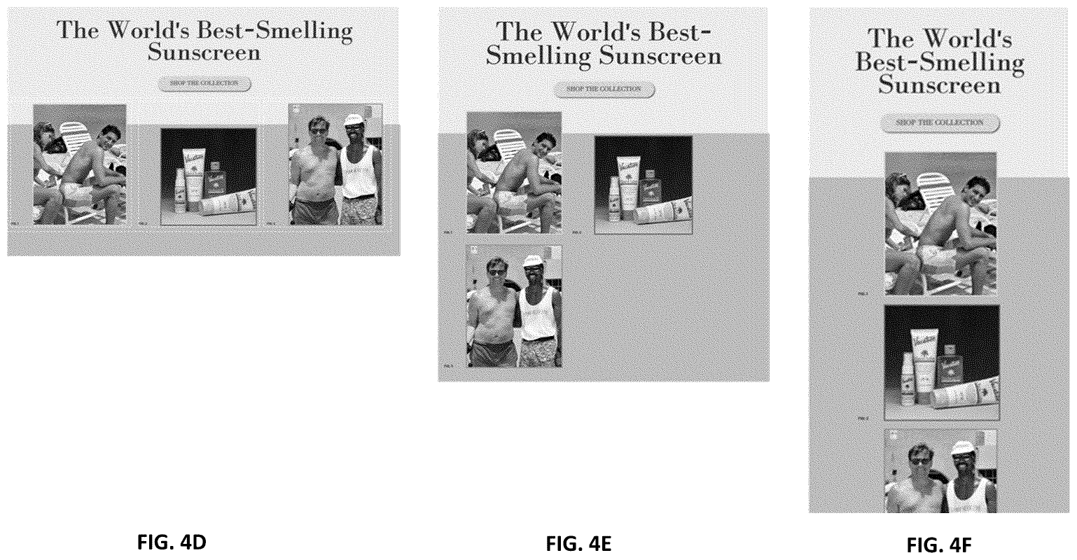

FIGS. 4A-4F depict example user interfaces in accordance with embodiments herein.

FIGS. 4A, 4B, 4C demonstrate an example flow involving receiving as input a static design and outputting fully responsive website. Shown in FIG. 4A, an editing user may place elements manually in an editing interface (e.g., also referred to as an Editor) and adjust them as a 2D design (the site is not responsive yet). Once the responsive optimization techniques described herein are applied, the output is a responsive webpage/section for desktop (FIG. 4B) and mobile (FIG. 4C) throughout the lower breakpoints.

FIGS. 4D, 4E, 4F demonstrate an example flow involving receiving as input a static design file (e.g., a Figma file) and outputting fully responsive website. Embodiments herein may be automatically invoked after importing a static design file from a static design system (such as Figma) to automatically generate a website (structure) that is responsive across screen widths. Shown n FIG. 4D, a user imports a static design file from any design software (e.g., Figma) and it is converted to a website in the editor. Once the responsive optimization techniques described herein are applied, the output is a responsive webpage/section for tablet (FIG. 4E) and mobile (FIG. 4F) throughout the lower breakpoints. That is, an example static Figma file shown in FIG. 4D may be imported with indications of the detected groups based on the layout understanding model or module described herein. The file may then be placed with layout techniques described herein. The output includes fully responsive layouts in smaller screen sizes of tablet (FIG. 4E) and mobile (FIG. 4F). The user experience may include feedback collection throughout the flow to improve predictions, detections, and outcome of models and modules of the present disclosure.

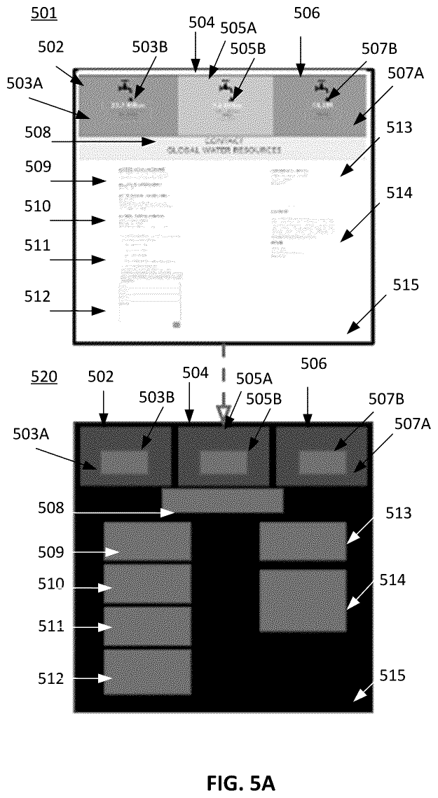

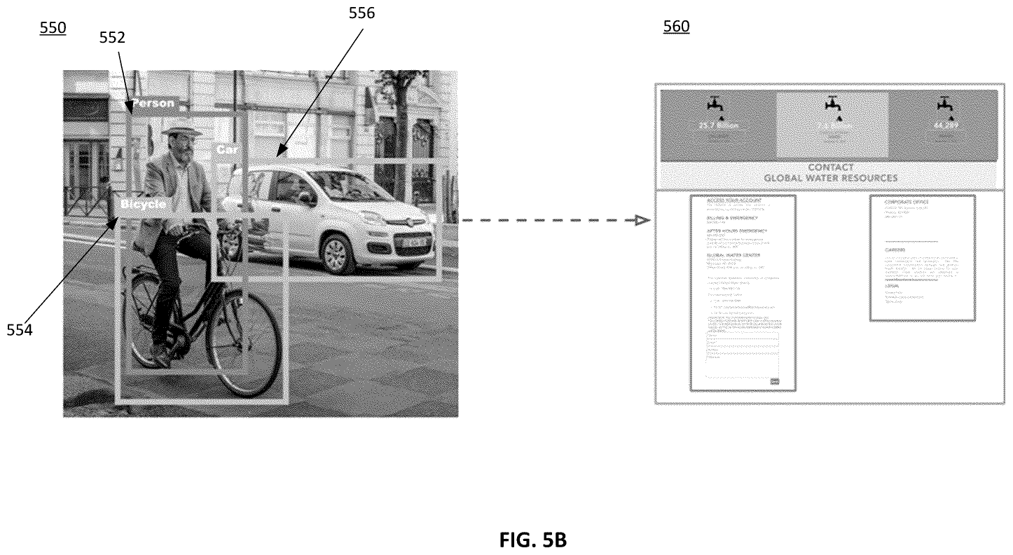

FIGS. 5A and 5B depict example detection and representation mechanisms in accordance with example embodiments described herein. Shown in FIG. 5A, embodiments of the present disclosure may represent a webpage 501 as high contrast image 520, and each component type can be color-coded (e.g., blue, red, and black in 520 of FIG. 5A).

For example, shown in FIG. 5A, a first section 502 may include a first component type 503A and a second component type 503B such that those may be color coded and included in the high contrast image 520. Similarly, a second section 504 may include a first component type 505A and a second component type 505B such that those may be color coded and included in the high contrast image 520. Similarly, a third section 506 may include a first component type 507A and a second component type 507B such that those may be color coded and included in the high contrast image 520. The remainder of the webpage 501 may include other component types 508, 509, 510, 511, 512, 513, 514, and 515, that may be color coded and reflected in the high contrast image 520. It will be appreciated that, for example, while in the example depicted in FIG. 5A, first component type 505A and first component type 503A are color coded to as the same component type, in other examples first component type 505A may be different from or the same as first component type 503A. The same may be true for the other component types depicted in FIG. 5A.

Shown in FIG. 5B, embodiments of the present disclosure may use object detection algorithms to detect the different objects on a webpage. For example, in image 550, object detection may be used to detect that there is a person 552 (bounded by the system using an orange box), riding a bicycle 554 (bounded by the system using a yellow box), as well as a car 556 (bounded by the system using a yellow box). Object detection (as well as other techniques as described herein) may be used to detect various sections of webpage 560 (which are bounded by the system using green boxes as shown in FIG. 5B).

### Example Terminology

As used herein, the term “layout” may be used to refer to a two-dimensional spatial structure of the visual elements in a webpage. A layout may implement element display priority (a.k.a. Z-index) (e.g., element A is in front of element B and thus is displayed “on top” of or overlaid on B). Display priority may be regarded as a 3^{rd} dimension of the layout. The layout may be determined by the sizes, positions, and other attributes of the elements. For an effective presentation of content, layouts may follow design guidelines or aesthetic principles. That is, a well-designed layout may enable an end user to quickly and easily perceive the information presented on a webpage.

As used herein, the term “grouping” may refer to capturing the perceptual structure of a layout. Grouping may be used in graphical design tools and in modern website builders. A group is defined as a collection of related visual elements that are associated together, and hierarchical grouping is the hierarchical arrangement of such groups. Grouping may be performed using one or more of the trained models described herein, including a trained layout model. The trained layout model may group structural or other elements of the webpage based on content of the website, predicted semantics associated with the structural elements, and other data.

As used herein, the term “semantics” may refer to aspects of elements of a website. For example, for text elements, semantics may include title, subtitle, and more. For groups of elements, semantics may include whether the group is a list (e.g., containing a repeating pattern of elements), a stackable container (e.g., elements arranged side-by-side horizontally or top-to-bottom vertically), a menu, a contact form, and more. The listed set of options for a group structure may be illustrative, and the actual set of options may be different and may include some, all, or different options.

The term “digital objects” refers to digital files having characteristics that may be extracted to that they may serve the basis for one or more of structure, theme, content, or layout of a website assembled using a website building system. Examples of digital objects include text files, image files, video files, URLs, websites, portions of websites, audio files, or the like.

The term “trained layout model” refers to a trained machine learning model or neural network model specifically configured to generate output responsive to an input object, where the output is a layout graph data structures. The trained layout model may be configured to generate the layout graph data structure based on inferring a hierarchical structure of a webpage associated with the input object and predicting semantics associated with groups and structural elements of the hierarchical structure of the webpage.

The terms “layout data structure” or “layout graph data structure” refer to a digital data structure representative of a hierarchical structure of a webpage. The layout graph data structure may include elements of the webpage, relationships between the elements of the webpage, and/or semantics associated with the elements of the webpage. In some embodiments, a layout graph data structure may be represented as a tree structure.

The terms “input object” and “input data object” refer to one or more items of data, sometimes files, comprising one or more website elements for use in generating a responsive website design. An input data object may include one or more website building tools. An input object may further include historical website editing interactions associated with one or more website editing users or a plurality of website editing users associated with a website building system with which the optimized webpage is being assembled. The input object may further include interactions associated with an editing user associated with an editing user identifier interacting with elements of a website building system. The input object may include semantic features (e.g., semantic-related enhancements associated with one or more components of the input object), contextual features (e.g., context-related enhancements associated with one or more components of the input object), and/or content (e.g., text, images, etc.).

The terms “multi-dimensional graph data structure” or “multi-dimension graph” refer to a multi-dimensional data structure, sometimes embodied as a tree data structure, which is generated based on extracted website elements and may represents the elements of the website and the relationships between them. The multi-dimensional graph may include a plurality of nodes and a plurality of edges, where an edge of the plurality of edges represents a relationship between two or more nodes of the plurality of nodes. In some examples, a node represents a visual element of the elements of the webpage and an edge represents a containment relationship between two or more visual elements. In some embodiments, a node may be associated with a node identifier, a node index, an element size, an element position, textual attributes, children node identifiers, and/or the like. A node identifier may be one or more items of data by which a node is uniquely identified.

The term “trained structure optimization model” refers to a trained machine learning model specifically configured to generate webpage layout data structures based on a layout graph data structure. The webpage layout data structures may be data structures that represent variations of layouts of a webpage with varying parameters. Webpage layout data structures may contain one or more items of data associated with a layout of a webpage and associated parameters such that multiple webpage layout data structures may represent different variations of a layout with differing associated parameters. It will be appreciated that not every parameter is different across the different variations of layouts.

An example trained structure optimization model may be configured to take as input one or more of input object, a layout graph data structure, semantic predictions for groups and structural elements of a webpage associated with the input object, confidence scores associated with the semantic predictions, design intent of an editing user associated with the input object, and user preferences associated with the editing user. In some examples, a trained structure optimization model applies grouping, stacking, or placement of structural elements of a webpage.

The term “trained responsive optimization model” refers to a trained machine learning model specifically configured to generate optimized webpages that are configured to render according to a plurality of screen parameters, based on receiving the plurality of screen parameters and one or more webpage layout data structures as input. That is, the term “optimized” used herein with reference to “optimized webpages” refers to the configuring of instructions that when executed render a webpage according to a plurality of screen parameters such that the content may render within a display device regardless of a screen size. The optimization may be accomplished according to embodiments herein and may involve adding instructions to the executable instructions for rendering the website so that design changes are triggered based on the screen parameters at a time of rendering. The trained responsive optimization model may be trained and retrained using historical website editing interactions, editing user intent, website data, system design guidelines, and the like.

The term “screen parameters” refers to constraints associated with a display device or user interface of an electronic device. In some examples, screen parameters include height, width, orientation, and breakpoints.

The terms “website building tools” or “website building components” refer to structural objects or electronic building blocks used to assemble a website in accordance with a website building system as described herein. By way of example, website building tools may include pages, sub-pages, containers, components, atomic components, content elements, layout elements, templates, layouts, layout rules, add-on applications, third-party applications, procedural code, application programming interfaces, and the like. It will be appreciated that, while reference may be made herein to examples of website building components being different types of components, a website building component may be a singular component object (e.g., a button, text field, image, or the like), or a multi-component object used for assembly of a website without departing from the scope of the present disclosure.

The terms “website editing historical interactions,” “editing historical interactions,” and “historical editing interactions” refer to electronic interactions performed by client computing devices associated with editing user identifiers in the course of assembling a website in accordance with a website building system as described herein. For example, such interactions may include editing or selections of content, logic, layout, templates, elements, attributes, and/or temporal aspects of the interactions including timing between edits or selections. By way of further example, such interactions may include electronic interactions (e.g., mouse clicks, touch screen selections, cursor hovers, cursor selections, and/or the like) with website building tools, and/or temporal aspects of the interactions including timing between the electronic interactions.

Website editing historical interactions may further refer to data related to a website structure, including data related to layout, components, themes, included verticals, component internal information (e.g., component parameters and attributes that have no immediate external expression), etc. Website editing historical interactions may further refer to data related to the creation of a website, including editing history, user profile and parameters (detailed herein), other sites by the same or related users, as well as the aforementioned interactions, etc. Website editing historical interactions may further refer to data related to site back-end and front-end, internal code elements, and the like, as well as data related to users of the website (e.g., end users or customers of the editing users) and their interactions with the site (including site business intelligence, details of transactions, etc.).

The term “editing user identifier” refers to one or more items of data by which an editing user (e.g., a user building or editing a website using a website building system in accordance with embodiments herein) may be uniquely identified. For example, an editing user identifier may comprise one or more of an email address, a social media handle, ASCII text, encryption keys, identification certificates, a pointer, an IP address, a URL, a MAC address, a memory address, an object signature, a HASH value, or other unique identifier, or combinations thereof.

The term “website identifier” refers to one or more items of data by which a website may be uniquely identified. For example, a website identifier may comprise one or more of ASCII text, encryption keys, identification certificates, a pointer, an IP address, a URL, a MAC address, a memory address, an object signature, a HASH value, or other unique identifier, or combinations thereof.

The term “end-user data” refers to electronic interaction data associated with a plurality of end-user identifiers accessing a plurality of websites assembled in accordance with a website building system as defined herein.

The term “end-user identifier” refers to one or more items of data by which an end-user (e.g., a user accessing or interacting with a website assembled using a website building system in accordance with embodiments herein) may be uniquely identified. For example, an end-user identifier may comprise one or more of an email address, a social media handle, ASCII text, encryption keys, identification certificates, a pointer, an IP address, a URL, a MAC address, a memory address, an object signature, a HASH value, or other unique identifier, or combinations thereof.

The term “electronic interaction data” refers to electronic interactions performed by client devices with electronic interfaces (e.g., websites). Electronic interaction data may include interactions with a touch screen, mouse clicks, cursor positions, cursor hoverings, and the like. Electronic interaction data may further be associated with metadata, such as timestamps at a time which the electronic interaction occurred, such that the electronic interaction data includes temporal aspects.

The term “prompt engineering” refers to the practice of designing inputs for artificial intelligence (AI) tools that will cause the AI tools to produce desired results. Optimizing prompts for AI tools enables the efficient use of AI tools (e.g., LLMs or generative AI technologies) for a wide variety of use cases. With prompt engineering, text can be structured so that it can be interpreted and understood by a generative AI model. It will be appreciated that if any of the trained machine learning models described herein are implemented using LLMs or generative AI technologies, inputs to the various trained machine learning models may involve one or more prompts that are generated based on the inputs as described herein and are configured to obtain a desired result from the LLM or generative AI technology in as few prompts or turns as possible.

The terms “trained machine learning model,” “machine learning model,” “model,” or “one or more models” refer to a machine learning or deep learning task or mechanism. Machine learning is a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, or the like.

A machine learning model is initially fit or trained on a training dataset (e.g., a set of examples used to fit the parameters of the model). The model may be trained on the training dataset using supervised or unsupervised learning. The model is run with the training dataset and produces a result, which is then compared with a target, for input vectors in the training dataset. Based on the result of the comparison and the specific learning algorithm being used, the parameters of the model are adjusted. The model fitting may include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g., the number of hidden units in a neural network). In some embodiments, the model can be trained and/or trained in real-time (e.g., online training) while in use.

The machine learning models, one or more models, trained machine learning models, trained layout models, trained structure optimization models, trained responsive optimization models, as described above, may make use of multiple ML engines, e.g., for analysis, recommendation generating, transformation, and other needs.

The system may train different ML models for different needs and different ML-based engines. The system may generate new models (based on the gathered training data) and may evaluate their performance against the existing models. Training data may include any of the gathered information, as well as information on actions performed based on the various recommendations.

The ML models may be any suitable model for the task or activity implemented by an ML-based engine. Machine learning models are known in the art and are typically some form of neural network. The term refers to the ability of systems to recognize patterns on the basis of existing algorithms and data sets to provide solution concepts. The more they are trained, the greater knowledge they develop.

The underlying ML models may be learning models (supervised or unsupervised). As examples, such algorithms may be prediction (e.g., linear regression) algorithms, classification (e.g., decision trees, k-nearest neighbors) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders, transformer-based), models combining planning with other models (e.g., PDDL-based), or Generative models (e.g., GANs, diffusion-based models).

Alternatively, ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks, diffusion-based or auto-encoders) to generate definitions and elements.

In various embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein.

In various embodiments and when appropriate for the particular task, one or more of the ML models may be implemented with rule-based systems, such as an expert system or a hybrid intelligent system that incorporates multiple AI techniques.

A rule-based system is used to store and manipulate knowledge to interpret information in a useful way. It is often used in artificial intelligence applications and research. Rule-based systems constructed using automatic rule inference, such as rule-based machine learning, may be included in this system type. An example a rule-based system is a domain-specific expert system that uses rules to make deductions or choices. For example, an expert system might help a doctor choose the correct diagnosis based on a cluster of symptoms, or select tactical moves to play a game. Rule-based systems can be used to perform lexical analysis to compile or interpret computer programs, or in natural language processing. Rule-based programming attempts to derive execution instructions from a starting set of data and rules.

A hybrid intelligent system employs, in parallel, a combination of methods and techniques from artificial intelligence subfields, such as: Neuro-symbolic systems; Neuro-fuzzy systems; Hybrid connectionist-symbolic models; Fuzzy expert systems; Connectionist expert systems; Evolutionary neural networks; Genetic fuzzy systems; Rough fuzzy hybridization; and/or Reinforcement learning with fuzzy, neural, or evolutionary methods as well as symbolic reasoning methods.

An example hybrid is a hierarchical control system in which the lowest, reactive layers are sub-symbolic. The higher layers, having relaxed time constraints, are capable of reasoning from an abstract world model and performing planning. Intelligent systems usually rely on hybrid reasoning processes, which include induction, deduction, abduction and reasoning by analogy.

The term “semantic” may refer to meaning conveyed by or attached to one or more components or features. Non-limiting examples of semantics may include a header, contact, information, a list, a footer, article, form, details, and more. Semantics may be associated with tags that convey the role of the content contained in one or more components or features.

The term “contextual features” or “context” may refer to one or more conditions (e.g., contexts) that may trigger reactions to a condition. For example, a contextual website may understand what an end user does and react to the user (e.g., showing the user relevant content, calls-to-action, and more). The term “context” may also refer to the purpose and usage of a website or one or more components of the website, such that context represents an understanding of how end users will interact with the website to achieve intended goals of the website.

The terms “client device,” “computing device,” “user device,” “client computing entity” “client computing device” and the like may be used interchangeably to refer to computer hardware that is configured (either physically or by the execution of software) to access one or more of an application, service, or repository made available by a server and, among various other functions, is configured to directly, or indirectly, transmit and receive data. The server is often (but not always) on another computer system, in which case the client device accesses the service by way of a network.

Example client devices include, without limitation, smartphones, tablet computers, laptop computers, wearable devices (e.g., integrated within watches or smartwatches, eyewear, helmets, hats, clothing, earpieces with wireless connectivity, and the like), personal computers, desktop computers, enterprise computers, the like, and any other computing devices known to one skilled in the art in light of the present disclosure. In some embodiments, a client device is associated with a user.

The terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization, or other physical properties transmitted through the transmission media.

Examples of non-transitory computer-readable media include a magnetic computer-readable medium (e.g., a floppy disk, hard disk, magnetic tape, or any other magnetic medium), an optical computer-readable medium (e.g., a compact disc read-only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer may read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

The terms “application,” “software application,” “app,” “product,” “service” or similar terms refer to a computer program or group of computer programs designed to perform coordinated functions, tasks, or activities for the benefit of a user or group of users. A software application may run on a server or group of servers (e.g., physical or virtual servers in a cloud-based computing environment). In certain embodiments, an application is designed for use by and interaction with one or more local, networked or remote computing devices, such as, but not limited to, client devices. Non-limiting examples of an application comprise website editing services, document editing services, word processors, spreadsheet applications, accounting applications, web browsers, email clients, media players, file viewers, collaborative document management services, videogames, audio-video conferencing, and photo/video editors.

In some embodiments, an application is a cloud product. When associated with a client device, such as a mobile device, communication with hardware and software modules executing outside of the application is typically provided via application programming interfaces (APIs) provided by the mobile device operating system.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The terms “illustrative,” “example,” “exemplary” and the like are used herein to mean “serving as an example, instance, or illustration” with no indication of qualitative assessment or quality level. Any implementation described herein as “exemplary” is not necessarily to be construed as preferred or advantageous over other implementations.

The phrases “in one embodiment,” “according to one embodiment,” and the like generally mean that the particular feature, structure, or characteristic following the phrase may be included in the at least one embodiment of the present disclosure and may be included in more than one embodiment of the present disclosure (importantly, such phrases do not necessarily refer to the same embodiment).

The terms “about,” “approximately,” or the like, when used with a number, may mean that specific number, or alternatively, a range in proximity to the specific number, as understood by persons of skill in the art field.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The term “plurality” refers to two or more items.

The term “set” refers to a collection of one or more items. In some embodiments, a “set” may refer to a data structure or a construct having zero items such that it is an empty set.

The term “or” is used herein in both the alternative and conjunctive sense, unless otherwise indicated.

### Data Use, Privacy, and Training Data

It will be appreciated that use of data by systems and embodiments herein are subject to terms, rights, laws, and regulations. These may include rights, laws, and regulations related to privacy (such as EU GDPR or California's CCPA), IP rights (such as copyrights or publicity rights), other property rights, site terms and conditions, and the like. Embodiments herein may implement a specific (opt-in or opt-out) directive that allows users to specify that their website information (or parts thereof) would not be used in AI training input. Furthermore, the system may implement such a directive at various levels of granularity (e.g., as a simple binary decision for site information or allow the user to specify in detail what information to use and what not to use).

Embodiments may implement some degree of reciprocity in using such an Al exclusion directive. Thus, for example, the system may only allow users to benefit from training performed on certain types of data if they themselves enable this data to be gathered from their websites. Such granular inputs and outputs may be implemented through the layering of multiple AI models and combining the results provided by these models. Specific models would be trained with different relevant subsets or levels of input data.

Embodiments herein may manage the training access permission using a layered or “levels of access” model (similar to traditional security classification models, e.g., unclassified/classified/secret/top secret). The system may train different AI models to different classification levels.

In some cases, embodiments may employ a “vertical” instead of (or in addition to) a “horizontal” division of data and models (“data silo” rather than a “data layer”). For example, a large enterprise may have numerous websites and would like to have training data exchange between its various websites (so employees would benefit from the collected internal knowledge) without allowing some or all of their data to be used for AI model training (and thus risk its exposure). Various embodiments of the present disclosure may implement one or more AI models for such a data silo. These AI model(s) would be the model(s) trained using the segregated enterprise data.

In one embodiment, the system may support the use of plug-in (and separately trained) Al models, with their output integrated with the primary (or different layer) models. Various embodiments of the present disclosure may support separate hosting of such plug-in AI model and the code running it—for example, hosting provided by the enterprise whose data is included in the separate data silo. The system may manage the communication with this separate plug-in model via a well-defined channel (API, SPI, or otherwise). Thus, in such an embodiment, the enterprise can retain full control of its proprietary data-even when used as training data to an AI model.

A version of the method above may be implemented to help websites serve users of users (site visitors). Thus, a chatbot (for example) could be embedded into a users' website. This chatbot-if implemented in a clothing store website (for example), could reply to a query about the appropriate clothing combination for a given event or time of the year and respond by directing the user to given items in the store catalog. Such chatbot could communicate in a variety of input and output method including use of text and language, images, video, audio, or any biometric-type communication (e.g., motion detection, gaze detection, etc.).

The amount of data in some categories may be prohibitive for use in training data. This is especially true for use of end-user (site visitor) data, which is substantially higher in volume than per-user data (as a single website could have, for example, millions of users). Thus, for such categories of data, the system may use data minimization techniques and provide (as training input) data that is filtered, selected (according to given criteria), aggregated, or otherwise minimized in volume.

As noted above, when using actual website data to train AI models, there is a concern that the Al model will disclose some private or otherwise proprietary data. This is typically applicable to generative AI models but could apply to other models as well. The system may prevent such a PII disclosure by removing PII from the data at multiple stages (e.g., when the training data is prepared as well as using post-processing on generated AI engine output). The system may integrate multiple PII removal techniques based on the data type being handled. When removing PII, the system may replace the PII value with an alternative value. This way, the system may preserve website element relationships defined through common PII values. For example, an “our team” page may be related to multiple “team member” pages through reference to team member names. Removing the PII values (the names) altogether may break these site interconnections and thus prevent the AI engine from enriching its training. Thus, the system may replace PII values with an alternative value (which is consistent for a given PII value). The alternate value can be generated using hashing, encryption (including one-way encryption), random generation, a replacement value table, or other methods.

### Example Computing Systems, Methods, and Apparatuses of the Disclosure

Having set forth a series of definitions called-upon throughout this application, an example system architecture and example apparatus are described below for implementing example embodiments and features of the present disclosure.

Methods, apparatuses, systems, and computer program products of the present disclosure may be embodied by any of a variety of computing devices. For example, the method, apparatus, system, and computer program product of an example embodiment may be embodied by a networked device, such as a server or other network entity, configured to communicate with one or more devices, such as one or more client devices. Additionally, or alternatively, the computing device may include fixed computing devices, such as a personal computer or a computer workstation. Still, further, example embodiments may be embodied by any of a variety of mobile devices, such as a portable digital assistant (PDA), mobile telephone, smartphone, laptop computer, tablet computer, wearable, or any combination of the aforementioned devices.

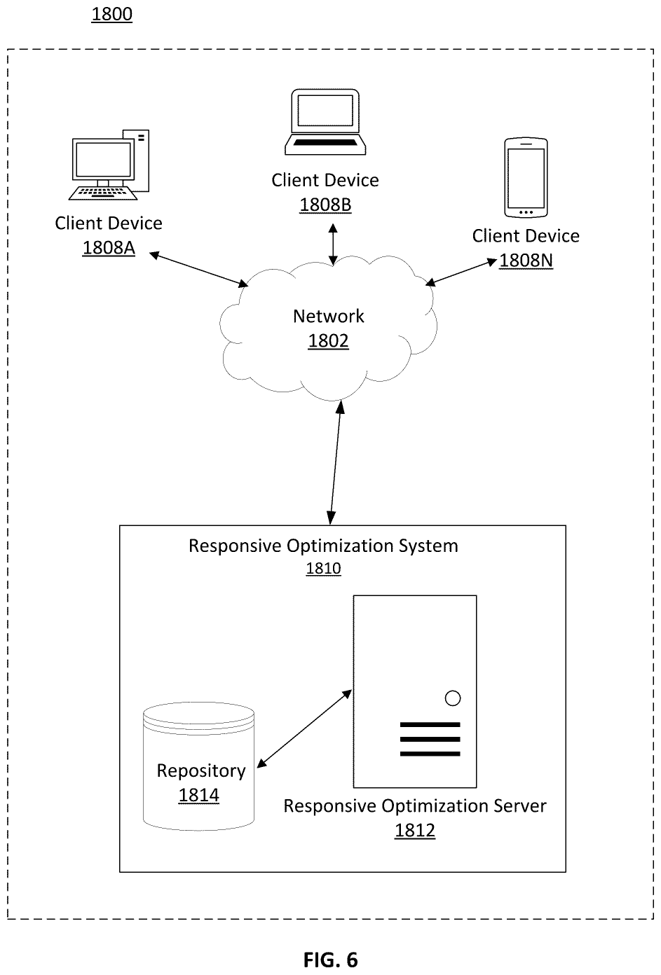

FIG. 6 illustrates a block diagram of an example system that may be specially configured within which embodiments of the present disclosure may operate. In this regard, FIG. 6 illustrates an overview of a computing system 1800 which may include one or more devices and sub-systems that are configured for performing some or all of the various operations and processes described herein. In some examples, such a system 1800 implements responsive optimization (RO) within a WBS via an RO system 1810 in accordance with some embodiments described herein.

The computing system 1800 is illustrated with an RO system 1810 communicably connected via a network 1802 to one or more client devices 1808A, 1808B, . . . 1808N (referred to as “client devices 1808”; the depictions in FIG. 6 of “N” client devices are merely for illustration purposes). Said differently, users may access the RO system 1810 over at least one communications network 1802 using one or more of client devices 1808. In some embodiments, the client devices 1808A-N are embodied by one or more user-facing computing devices embodied in hardware, software, firmware, and/or a combination thereof, configured for performing some or all of the RO system functionality described herein. That is, the client devices 1808A-N may include circuitry, modules, networked processors, a suitable network server, and/or other types of processing device (e.g., a controller or computing device of the client device 1808). For example, in some embodiments, a client device 1808A-N is embodied by a personal computer, a desktop computer, a laptop computer, a computing terminal, a smartphone, a netbook, a tablet computer, a personal digital assistant, a wearable device, a smart home device, and/or other networked devices that may be used for any suitable purpose in addition to performing some or all of the RO system functionality described herein. In some example contexts, the client device 1808A-N is configured to execute one or more computing programs to perform the various functionality described herein. For example, the client device 1808A-N may execute a web-based application or applet (e.g., accessible via a website), a software application installed to the client device 1808A-N(e.g., an “app”), or other computer-coded instructions accessible to the client device 1808.

In some embodiments, the client devices 1808A-N may include various hardware, software, firmware, and/or the like for interfacing with the RO system 1810. Said differently, a client device 1808A-N may be configured to access the RO system 1810 and/or to render information provided by the RO system 1810 (e.g., via a software application executed on the client device 1808). According to some embodiments, the client device 1808A-N comprises a display for rendering various interfaces. For example, in some embodiments, the client device 1808A-N is configured to display such interface(s) on the display of the client device 1808A-N for viewing, editing, and/or otherwise interacting with at least a selected component, which may be provided by the RO system 1810.

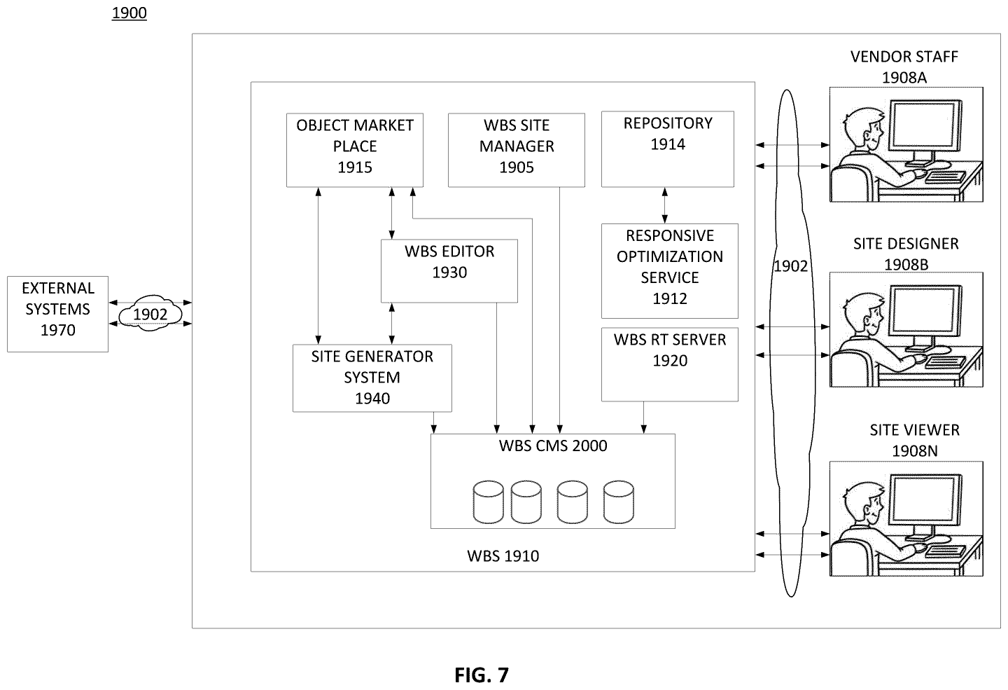

In some embodiments, the RO system 1810 includes one or more servers, such as RO server 1812. In some embodiments, the RO system 1810 comprises other servers and components, as described below with respect to the exemplary depicted embodiment of a website building system 1910 in FIG. 7.

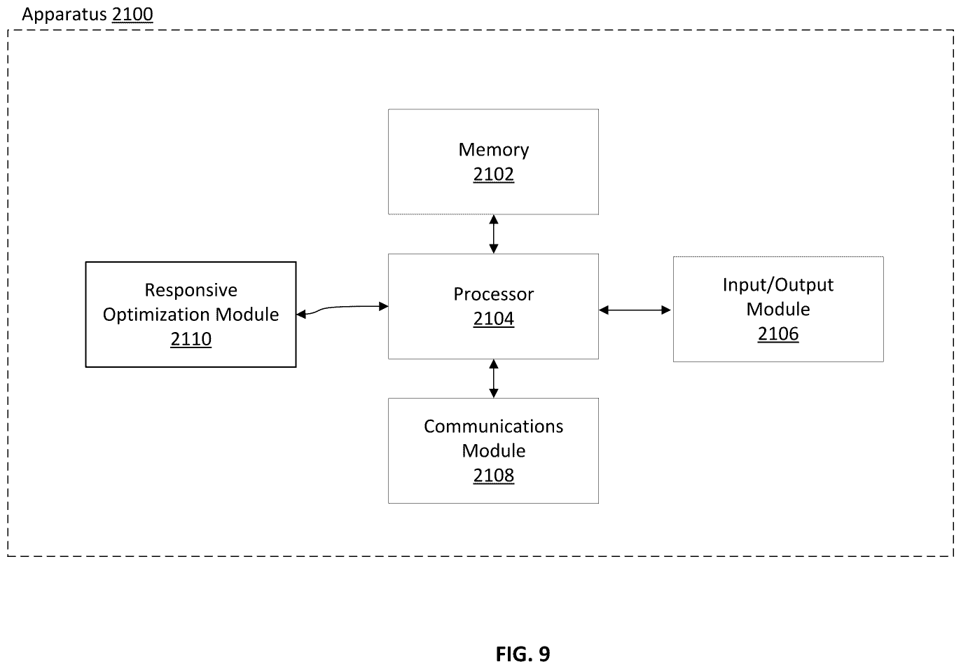

RO server 1812 may be any suitable network server and/or other type of processing device. In this regard, the RO server 1812 may be embodied by any of a variety of devices, for example, the RO server 1812 may be embodied as a computer or a plurality of computers. For example, RO server 1812 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least a portion of the components illustrated with respect to server apparatus 2100 in FIG. 9 and described in connection therewith. The RO server 1812 may, in some embodiments, comprise several servers or computing devices performing interconnected and/or distributed functions. Despite the many arrangements contemplated herein, RO server 1812 is shown and described herein as a single computing device to avoid unnecessarily overcomplicating the disclosure.

In some embodiments, the RO server 1812 is configured, via one or more software modules, hardware modules, or a combination thereof, to access communications network 1802 for communicating with one or more of the client devices 1808. Additionally or alternatively, the RO server 1812 is configured, via software, hardware, or a combination thereof, to is configured to execute any of a myriad of processes associated with the implementing RO. Said differently, RO server 1812 may include circuitry, modules, networked processors, or the like, configured to perform some or all of the RO functionality, as described herein. In this regard, for example, in some embodiments, the RO server 1812 receives and processes data. For example, the client devices 1808A-N and/or an application may communicate with the RO system 1810 (e.g., RO server 1812) via one or more application programming interfaces (APIs), web interfaces, web services, or the like.

In some embodiments, the RO system 1810 includes at least one repository, such as repository 1814. Such repository(ies) may be hosted by the RO server 1812 or otherwise hosted by devices in communication with the RO server 1812. As depicted, in some embodiments, the RO server 1812 is communicably coupled with the repository 1814. In some embodiments, the RO server 1812 may be located remotely from repository 1814. In this regard, in some embodiments, the RO server 1812 is directly coupled to repository 1814 within the RO system 1810.

Alternatively, or additionally, in some embodiments, the RO server 1812 is wirelessly coupled to the repository 1814. In yet other embodiments, the repository 1814 is embodied as a sub-system(s) of the RO server 1812. That is, the RO server 1812 may comprise repository 1814. Alternatively, or additionally, in some embodiments, the repository 1814 is embodied as a virtual repository executing on the RO server 1812.

The repository 1814 may be embodied by hardware, software, or a combination thereof, for storing, generating, and/or retrieving data and information utilized by the RO system 1810 for performing the operations described herein. The repository 1814, in some embodiments, may comprise an object repository, a structured repository, a semi-structured repository, or a non-structured repository. For example, repository 1814 may be stored by any suitable storage device configured to store some or all of the information described herein (e.g., memory 2102 of the RO server 1812 or a separate memory system separate from the RO server 1812, such as one or more database systems, backend data servers, network databases, cloud storage devices, or the like provided by another device (e.g., online application or 3rd party provider), such as a Network Attached Storage (NAS) device or devices, or as a separate database server or servers). Repository 1814 may comprise data received from the RO server 1812 (e.g., via a memory 2102 and/or processor(s) 1214) and/or a client device 1808, and the corresponding storage device may thus store this data. The repository 1814 may store various data in any of a myriad of manners, formats, tables, computing devices, and/or the like. For example, in some embodiments, the repository 1814 includes one or more sub-repositories that are configured to store specific data processed by the RO system 1810. Repository 1814 includes information accessed and stored by the RO server 1812 to facilitate the operations of the RO system 1810.

RO system 1810 (e.g., RO server 1812) may communicate with one or more client devices 1808A-N via communications network 1802. Communications network 1802 may include any one or more wired and/or wireless communication networks including, for example, a wired or wireless local area network (LAN), personal area network (PAN), metropolitan area network (MAN), wide area network (WAN), or the like, or combinations thereof, as well as any hardware, software and/or firmware required for implementing the one or more networks (e.g., network routers, switches, hubs, etc.). For example, communications network 1802 may include a cellular telephone, mobile broadband, long-term evolution (LTE), GSM/EDGE, UMTS/HSPA, IEEE 802.11, IEEE 802.16, IEEE 802.20, Wi-Fi, dial-up, and/or WiMAX network.

Furthermore, the communications network 1802 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. For instance, the networking protocol may be customized to suit the needs of the RO system 1810, such as JavaScript Object Notation (JSON) objects sent via a WebSocket channel. In some embodiments, the protocol is JSON over RPC, JSON over REST/HTTP, the like, or combinations thereof.

In some embodiments, the RO system 1810 is a standalone system. In other embodiments, the RO system 1810 is embedded inside a larger editing system. For example, in certain embodiments, the RO system 1810 is associated with a visual design system and further still, in some embodiments, the visual design system is one or more of a document building system, a website building system, or an application building system.

An example of an RO system (e.g., RO system 1810 as depicted in FIG. 6) is depicted in FIG. 7. In particular, FIG. 7 depicts a computing system 1900 including a website building system (“WBS”) 1910 as an example RO system for the creation and/or update of, for example, hierarchical websites.

A WBS 1910 may be online (e.g., applications are edited and stored on a server or server set), off-line, or partially online (with web sites being edited locally but uploaded to a central server for publishing). A WBS 1910 may be accessed by a variety of users via a network 1902, including designers, subscribers, subscribing users or site editors, and code editors, which are the users designing the web sites, as well as end users which are the “users of users” accessing the created web sites. Although end users may typically access the WBS 1910 in a read-only mode, a WBS (and web sites) may allow end users to perform changes to a web site, such as adding or editing data records, adding talkbacks to news articles, adding blog entries to blogs, and/or the like.

In some embodiments, a WBS 1910 may allow multiple levels of users and different permissions and capabilities may be associated with and/or assigned to various level. For example, users may register with the WBS 1910 (e.g., via the WBS server which manages the users, web sites, and access parameters of the end users).

With reference to FIG. 7, in addition to an RO service 1912, and a repository 1914, a WBS 1910 may comprise a WBS site manager 1905, an object marketplace 1915, a RT (runtime) server 1920, a WBS editor 1930, a site generation system 1940 and a WBS content management system 2000. WBS 1910 is depicted in communication with embodiments of the client devices 1808A-N which are depicted as being operated by WBS vendor staff 1908A, WBS site designer 1908B (e.g., a user), a site viewer 1908N (e.g., a user of a user), as well as external systems 1970. For example, WBS vendor staff 1908A may be an employee of the pertinent website building system vendor and may create and maintain various WBS elements such as templates, content/layout elements, and/or the like. In some embodiments, a site designer 1908B may use WBS 1910 to build his site for use by site viewers 1908N.

Additionally, or alternatively, a site designer 1908B may be an external site designer or consultant, though the website building system vendor may employ site designers 1908B, for example for the creation of template sites for inclusion in the WBS 1910. In some embodiments, site viewers 1908N may only view the system. Additionally, or alternatively, in some embodiments, site viewers 1908N may be allowed some form of site input or editing (e.g., talkback sending or blog article posting). In still further embodiments, WBS 1910 comprises a limited site generation system 1940 configured to allow a viewer 1908N to build (e.g., a user page) within a social networking site. It is contemplated by this disclosure that a site viewer 1908N may also include a site designer 1908B.

In some embodiments, WBS site manager 1905 is used by site designer 1908B to manage his created sites (e.g., to handle payment for the site hosting or set permissions for site access). In some embodiments, WBS RT (runtime) server 1920 handles run-time access by one or more (e.g., possibly numerous) site viewers 1908N. In some embodiments, such access is read-only, but in certain embodiments, such access involves interactions that may affect back-end data or front-end display (e.g., purchasing a product or posting a comment in a blog). In some embodiments, WBS RT server 1920 serves pages to site designers 1908B (e.g., when previewing the site, or as a front-end to WBS editor 1930).

In some embodiments, object marketplace 1915 allows trading of objects (e.g., as add-on applications, templates, and element types) between object vendors and site designers 1908B through WBS 1910. In some embodiments, WBS editor 1930 allows site designer 1908B to edit site pages (e.g., manually or automatically generated), such as editing content, logic, layout, attributes, and/or the like. For example, in some embodiments, WBS editor 1930 allows site designer 1908B to adapt a particular template and its elements according to her business or industry.

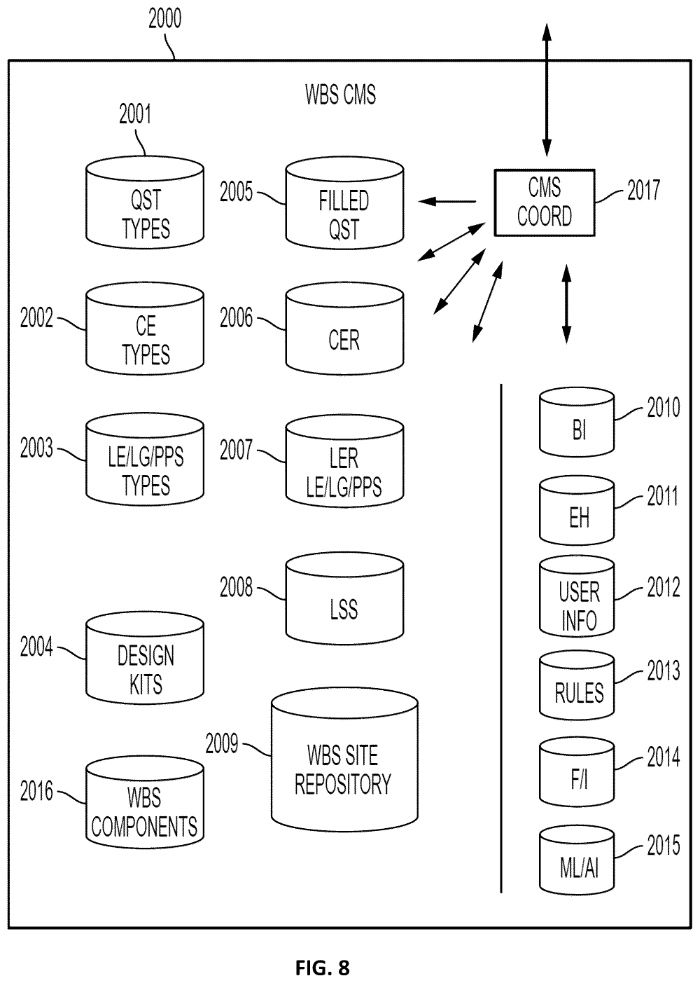

In some embodiments, site generation system 1940 creates the actual site based on the integration and analysis of information entered by site designer 1908B (e.g., via questionnaires), pre-specified and stored in content management system (CMS) 2000 together with information from external systems 1970 and internal information held within CMS 2000 that may be gleaned from the use of the WBS 1910 by other designers. Additionally, or alternatively, CMS 2000 is held in centralized storage or locally by site designer 1908B. Example repositories of a CMS 2000 are described below with respect to FIG. 8.

With reference to FIG. 8, an example CMS 2000 is illustrated. The WBS 1910 may utilize a CMS 2000, comprising a series of repositories, stored over one or more servers or server farms, to support the creation of various websites. For example, CMS 2000 may include one or more of user information/profile repository 2012, WBS component repository 2016, WBS site repository 2009, business intelligence (BI) repository 2010, and editing history repository 2011. Additionally or alternatively, CMS 2000 may include one or more of questionnaire type repository 2001, content element (CE) type repository 2002, LE (layout element) type repository 2003, design kit repository 2004, filled questionnaires repository 2005, CER (content element repository) 2006, LER (layout element repository) 2007, layout selection store 2008, rules repository 2013, family/industry repository 2014, and ML/AI (machine learning/artificial intelligence) repository 2015. A CMS 2000 may also include a CMS coordinator 2017 to coordinate and control access to such one or more repositories.

It is contemplated by this disclosure that the WBS 1910 may be used to create and/or update hierarchical websites based on visual editing or automatic generation based on collected business knowledge, where collected business knowledge refers to the collection of relevant content to the web site being created which may be gleaned from, for example, external systems 670 or other sources. Further details regarding collected business knowledge are described in commonly-owned U.S. Pat. No. 10,073,923, which was filed May 29, 2017, as U.S. patent application Ser. No. 15/607,586, and is entitled “SYSTEM AND METHOD FOR THE CREATION AND UPDATE OF HIERARCHICAL WEBSITES BASED ON COLLECTED BUSINESS KNOWLEDGE,” which application is incorporated by reference herein in its entirety.

In some embodiments, WBS 1910 uses internal data architecture to store WBS-based sites. For example, this architecture may organize the handled sites' internal data and elements inside the WBS 1910. This architecture may be different from the external view of the site (as seen, for example, by the end-users) and may also be different from the way the corresponding HTML pages sent to the browser are organized. For example, in some embodiments, the internal data architecture contains additional properties for elements in the page (e.g., creator, creation time, access permissions, link to templates, SEO-related information, and/or the like) that are relevant for the editing and maintenance of the site in the WBS 1910 but are not externally visible to end-users (or even to some editing users). The internal version of the sites may be stored in a site repository as further detailed below.

In some embodiments, a WBS 1910 is used with applications. For example, a visual application is a website including pages, containers, and components. The pages are separately displayed and includes one or more components. In some embodiments, components include containers as well as atomic components. In some embodiments, the WBS 1910 supports hierarchical arrangements of components using atomic components (e.g., text, image, shape, video, and/or the like) as well as various types of container components which contain other components (e.g., regular containers, single-page containers, multi-page containers, gallery containers, and/or the like). The sub-pages contained inside a container component are referred to as mini-pages, some of which may contain multiple components. Some container components may display just one of the mini-pages at a time, while others may display multiple mini-pages simultaneously.

In some examples, pages may use templates-general page templates or component templates. In an exemplary embodiment, an application master page containing components replicated in some or all other regular pages is a template. In another exemplary embodiments, an application header/footer, which repeats on some or all pages, is a template. In some embodiments, templates may be used for the complete page or page sections. A WBS 1910 may provide inheritance between templates, pages or components, possibly including multi-level inheritance, multiple inheritance and diamond inheritance (e.g., A inherits from B and C, and both B and C inherit from D). In some embodiments, a WBS 1910 supports site templates.

In some embodiments, the visual arrangement of components inside a page is a layout. In some embodiments, a WBS 1910 supports dynamic layout processing whereby the editing of a given component (or other changes affecting it such as externally-driven content change) may affect other components. Further details regarding dynamic layout processing are described in commonly-owned U.S. Pat. No. 10,185,703, which was filed Feb. 20, 2013, as U.S. patent application Ser. No. 13/771,119, and is entitled “WEB SITE DESIGN SYSTEM INTEGRATING DYNAMIC LAYOUT AND DYNAMIC CONTENT,” which is incorporated by reference herein in its entirety.

In some embodiments, a WBS 1910 is extended using add-on applications, such as third-party applications and components, list applications, and WBS configurable applications. In certain embodiments, such add-on applications may be added and integrated into designed web sites. Such add-on applications may be purchased (or otherwise acquired) through a number of distribution mechanisms, such as being pre-included in the WBS design environment, from an application store (e.g., integrated into the WBS object marketplace 1915 or external) or directly from the third-party vendor. Such third-party applications may be hosted on the servers of the WBS vendor, the servers of the third-party application's vendor, and/or a 4th party server infrastructure.

In some embodiments, a WBS 1910 allows procedural code to be added to some or all of the entities (e.g., applications, pages, elements, components, and the like). Such code could be written in a standard language (such as JavaScript), an extended version of a standard language or a language proprietary to the specific WBS 1910. The executed code may reference APIs provided by the WBS 1910 itself or external providers. The code may also reference internal constructs and objects of the WBS 1910, such as pages, components and their attributes.

In some embodiments, the procedural code elements may be activated via event triggers which may be associated with user activities (e.g., mouse move or click, page transition and/or the like), activities associated with other users (e.g., an underlying database or a specific database record being updated by another user and/or the like), system events or other types of conditions. The activated code may be executed inside the WBS's client element (e.g., client devices 1808), the server platform, a combination of the two or a dynamically determined execution platform. Further details regarding activation of customized back-end functionality are described in commonly-owned U.S. Pat. No. 10,209,966, which was filed on Jul. 24, 2018, as U.S. patent application Ser. No. 16/044,461, and is entitled “CUSTOM BACK-END FUNCTIONALITY IN AN ONLINE WEBSITE BUILDING ENVIRONMENT,” which patent is incorporated by reference herein in its entirety.

FIG. 9 illustrates a block diagram of an example apparatus that may be specially configured in accordance with an example embodiment of the present disclosure. In some embodiments, RO system 1810 and/or RO server 1812 is embodied by one or more computing systems, such as the apparatus 2100 as depicted and described in FIG. 9.

FIG. 9 shows a schematic block diagram of example modules or circuitry, some or all of which may be included in server apparatus 2100. As illustrated in FIG. 9, in accordance with some example embodiments, the server apparatus 2100 may include various means, such as memory 2102, processor 2104, input/output module 2106, communications module 2108, and/or RO module 2110. The server apparatus 2100 may be configured, using one or more of the modules 2102-2110, to execute the operations regarding implementing RO functionality with respect to FIGS. 1A-5B. Said differently, systems, methods, apparatuses, and/or computer program products as described herein are configured to transform or otherwise manipulate a general-purpose computer(s) so that it functions as a special-purpose computer to provide responsive optimization (RO) as described herein.

Although the use of the terms “module” and “circuitry” as used herein with respect to components 2102-2110 are described in some cases using functional language, it should be understood that the particular implementations necessarily include the use of particular hardware configured to perform the functions associated with the respective module or circuitry as described herein. It should also be understood that certain of these components 2102-2110 may include similar or common hardware. For example, two or more modules may both leverage use of the same processor, network interface, storage medium, or the like to perform their associated functions, such that duplicate hardware is not required for each module. It will be understood in this regard that some of the components or modules described in connection with the RO server 1812, for example, may be housed within this device, while other components or modules are housed within another of these devices, or by yet another device not expressly illustrated in FIG. 9. Said differently, in some embodiments, one or more external systems (such as a remote cloud computing and/or data storage system) may also be leveraged to provide at least some of the functionality discussed herein.

While the terms “module” and “circuitry” should be understood broadly to include hardware, in some embodiments, the terms “module” and “circuitry” also include software for configuring the hardware. That is, in some embodiments, each of the modules 2102-2110 may be embodied by hardware, software, or a combination thereof, for performing the operations described herein. In some embodiments, some of the modules 2102-2110 may be embodied entirely in hardware or entirely in software, while other modules are embodied by a combination of hardware and software. For example, in some embodiments, the terms “module” and “circuitry” may include processing circuitry, storage media, network interfaces, input/output devices, and the like. In some embodiments, other elements of the server apparatus 2100 may provide or supplement the functionality of a particular module or circuitry. For example, the processor 2104 may provide processing functionality, the memory 2102 may provide storage functionality, the communications module 2108 may provide network interface functionality, and the like.

In some embodiments, one or more of the modules 2102-2110 may share hardware, to eliminate duplicate hardware requirements. Additionally, or alternatively, in some embodiments, one or more of the modules 2102-2110 may be combined, such that a single module includes means configured to perform the operations of two or more of the modules 2102-2110. Additionally, or alternatively, one or more of the modules 2102-2110 may be embodied by two or more submodules.

In some embodiments, the processor 2104 (and/or co-processor or any other processing circuitry assisting or otherwise associated with the processor) may be in communication with the memory 2102 via a bus for passing information among components of, for example, RO server 1812. The memory 2102 is non-transitory and may include, for example, one or more volatile and/or non-volatile memories, or some combination thereof. In other words, for example, the memory 2102 may be an electronic storage device (e.g., a non-transitory computer readable storage medium). The memory 2102 may be configured to store information, data, content, applications, instructions, or the like, for enabling server apparatus 2100 (e.g., RO server 1812) to carry out various functions in accordance with example embodiments of the present disclosure.

Although illustrated in FIG. 9 as a single memory, memory 2102 may comprise a plurality of memory components. The plurality of memory components may be embodied on a single computing device or distributed across a plurality of computing devices. In various embodiments, memory 2102 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 2102 may be configured to store information, data, applications, instructions, or the like for enabling server apparatus 2100 to carry out various functions in accordance with example embodiments discussed herein. For example, in at least some embodiments, memory 2102 is configured to buffer data for processing by processor 2104. Additionally, or alternatively, in at least some embodiments, memory 2102 is configured to store program instructions for execution by processor 2104. Memory 2102 may store information in the form of static and/or dynamic information. This stored information may be stored and/or used by the server apparatus 2100 (e.g., RO server 1812) during the course of performing its functionalities.

Processor 2104 may be embodied in a number of different ways and may, for example, include one or more processing devices configured to perform independently. Additionally, or alternatively, processor 2104 may include one or more processors configured in tandem via a bus to enable independent execution of instructions, pipelining, and/or multithreading. Processor 2104 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 9 as a single processor, in some embodiments, processor 804 comprises a plurality of processors. The plurality of processors may be embodied on a single computing device or may be distributed across a plurality of such devices collectively configured to function as RO server 1812. The plurality of processors may be in operative communication with each other and may be collectively configured to perform one or more functionalities of RO server 1812 as described herein.

In an example embodiment, processor 2104 is configured to execute instructions stored in the memory 2102 or otherwise accessible to processor 2104. Alternatively, or additionally, the processor 2104 may be configured to execute hard-coded functionality. As such, whether configured by hardware or software methods, or by a combination thereof, the processor 2104 may represent an entity (e.g., physically embodied in circuitry) capable of performing operations according to an embodiment of the present disclosure while configured accordingly. Alternatively, as another example, when the processor 2104 is embodied as an executor of software instructions, the instructions may specifically configure processor 2104 to perform one or more algorithms and/or operations described herein when the instructions are executed. For example, these instructions, when executed by processor 2104, may cause the server apparatus 2100 (e.g., RO server 1812) to perform one or more of the functionalities of system 1800 as described herein.

In some embodiments, the server apparatus 2100 further includes input/output module 2106 that may, in turn, be in communication with processor 2104 to provide an audible, visual, mechanical, or other output and/or, in some embodiments, to receive an indication of an input from a user, a client device 1808, or another source. In that sense, input/output module 2106 may include means for performing analog-to-digital and/or digital-to-analog data conversions. Input/output module 2106 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output module 2106 may comprise a user interface and may comprise a web user interface, a mobile application, a client device, a kiosk, or the like. The processor 2104 and/or user interface circuitry comprising the processor 2104 may be configured to control one or more functions of a display or one or more user interface elements through computer program instructions (e.g., software and/or firmware) stored on a memory accessible to the processor 2104 (e.g., memory 2102, and/or the like). In some embodiments, aspects of input/output module 2106 may be reduced as compared to embodiments where server apparatus 2100 may be implemented as an end-user machine or other type of device designed for complex user interactions. In some embodiments (like other components discussed herein), input/output module 2106 may even be eliminated from server apparatus 2100. Input/output module 2106 may be in communication with memory 2102, communications module 2108, and/or any other component(s), such as via a bus. Although more than one input/output module 2106 and/or other component may be included in server apparatus 2100, only one is shown in FIG. 9 to avoid overcomplicating the disclosure (e.g., like the other components discussed herein).

Communications module 2108, in some embodiments, includes any means, such as a device or circuitry embodied in either hardware, software, firmware or a combination of hardware, software, and/or firmware, that is configured to receive and/or transmit data from/to a network and/or any other device, circuitry, or module in communication with server apparatus 2100. In this regard, communications module 2108 may include, for example, a network interface for enabling communications with a wired or wireless communication network. For example, in some embodiments, communications module 2108 is configured to receive and/or transmit any data that may be stored by memory 2102 using any protocol that may be used for communications between computing devices. For example, communications module 2108 may include one or more network interface cards, antennae, transmitters, receivers, buses, switches, routers, modems, and supporting hardware and/or software, and/or firmware/software, or any other device suitable for enabling communications via a network. Additionally, or alternatively, in some embodiments, communications module 2108 includes circuitry for interacting with the antenna(s) to cause transmission of signals via the antenna (c) or to handle receipt of signals received via the antenna (e). These signals may be transmitted by RO server 1812 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications module 2108 may additionally or alternatively be in communication with the memory 2102, input/output module 2106 and/or any other component of server apparatus 2100, such as via a bus.

In some embodiments, RO module 2110 is included in the server apparatus 2100 and configured to perform the functionality discussed herein related to responsive optimization (RO). In some embodiments, RO module 2110 includes hardware, software, firmware, and/or a combination of such components, configured to support various aspects of such responsive optimization-related functionality, features, and/or services of the RO module 2110 as described herein.

It should be appreciated that, in some embodiments, RO module 2110 performs one or more of such exemplary actions in combination with another module of the server apparatus 2100, such as one or more of memory 2102, processor 2104, input/output module 2106, and communications module 2108. For example, in some embodiments, RO module 2110 utilizes processing circuitry, such as the processor 2104 and/or the like, to perform one or more of its corresponding operations. In a further example, some or all of the functionality of RO module 2110 may be performed by processor 2104 in some embodiments. In this regard, some or all of the example responsive optimization processes and algorithms discussed herein may be performed by at least one processor 2104 and/or RO module 2110. It should also be appreciated that, in some embodiments, RO module 2110 may include a separate processor, specially configured field programmable gate array (FPGA), or application specific integrated circuit (ASIC) to perform its corresponding functions.

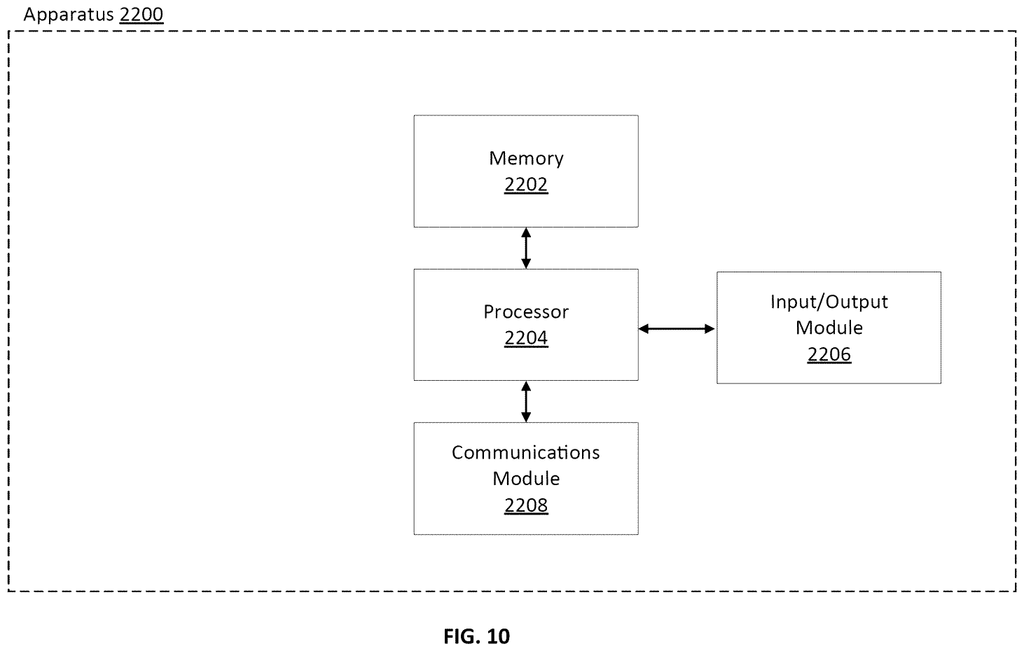

Additionally, or alternatively, in some embodiments, RO module 2110 utilizes memory 2102 to store collected information. For example, in some implementations, RO module 2110 includes hardware, software, firmware, and/or a combination thereof, that interacts with repository 1914 (as illustrated in FIG. 10) and/or memory 2102 to send, retrieve, update, and/or store data values embodied by and/or associated with the RO module 2110.

FIG. 10 illustrates a block diagram of an example client apparatus that may be specially configured in accordance with an example embodiment of the present disclosure. In some embodiments, the client device 1808A, 1808B, 1808N is embodied by one or more computing systems, such as the client apparatus 2200 as depicted and described in FIG. 10. The client apparatus 2200 includes a memory 2202, processor 2204, input/output module 2206, and communications module 2208. The client apparatus 2200 may be configured using one or more of the sets of circuitry to execute the operations described herein. The modules 2202-2208 may function similarly or identically to the similarly-named modules depicted and described with respect to the server apparatus 2100. For purposes of brevity, repeated disclosure with regard to the functionality of such similarly-named sets of circuitry is omitted herein.

In some embodiments, one or more of the modules 2202-2208 are combinable. Alternatively, or additionally, in some embodiments, one or more of the modules perform some or all of the functionality described associated with another component. For example, in some embodiments, one or more of the modules 2202-2208 are combined into a single module embodied in hardware, software, firmware, and/or a combination thereof.

Thus, particular embodiments of the subject matter have been described. While this specification contains many specific implementation details, these should not be construed as limitations on the scope of any inventions or of what may be claimed, but rather as description of features specific to particular embodiments of particular inventions. Other embodiments are within the scope of the following claims. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Any operational step shown in broken lines in one or more flow diagrams illustrated herein are optional for purposes of the depicted embodiment.

In some cases, the actions recited in the claims may be performed in a different order and still achieve desirable results. In addition, the processes depicted in the accompanying figures do not necessarily require the particular order shown, or sequential order, to achieve desirable results unless described otherwise. In certain implementations, multitasking and parallel processing may be advantageous.

Accordingly, non-transitory computer-readable storage media may be configured to store firmware, one or more application programs, and/or other software, which include instructions and/or other computer-readable program code portions that may be executed to control processors of the components of server apparatus 2100 and/or client apparatus 2200 to implement various operations, including the examples shown herein. As such, a series of computer-readable program code portions may be embodied in one or more computer program products and may be used, with a device, database, and/or other programmable apparatus, to produce the machine-implemented processes discussed herein. It is also noted that all or some of the information discussed herein may be based on data that is received, generated and/or maintained by one or more components of the RO server 1812 and/or client device 1808. In some embodiments, one or more external systems (such as a remote cloud computing and/or data storage system) may also be leveraged to provide at least some of the functionality discussed herein.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied in the computer-readable storage medium (e.g., computer software stored on a hardware device). Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus's circuitry to produce a machine, such that the computer, processor, or other programmable circuitry that execute the code on the machine creates the means for implementing various functions, including those described herein in connection with the components of RO server 1812 and client device 1808.

The computing systems described herein may include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with a client device or an admin user interacting with an admin device). Information/data generated at the client device may be received from the client device at the server.

The following example embodiments are provided, the numbering of which is not to be construed as designating levels of importance or relevance.

Example 1. An apparatus comprising one or more processors and at least one non-transitory computer-readable storage medium comprising instructions that, when executed by the one or more processors, cause the apparatus to: generate, based on applying a trained layout model to extracted website elements from an input object comprising one or more website building tools, a layout graph data structure; generate, based on applying a trained structure optimization model to the layout graph data structure, a webpage layout data structure; and generate, based on applying a trained responsive optimization model to the webpage layout data structure and a plurality of screen parameters, an optimized webpage that is configured to render according to the plurality of screen parameters.

Example 2. An apparatus according to the foregoing Example, further caused to receive, from a client computing entity, the input object.

Example 3. An apparatus according to any of the foregoing Examples, wherein the input object further comprises historical website editing interactions associated with one or more of a first website editing user identified associated with the optimized webpage or a plurality of website editing users associated with a website building system with which the optimized webpage is being assembled.

Example 4. An apparatus according to any of the foregoing Examples, wherein the input object further comprises an input file.

Example 5. An apparatus according to any of the foregoing Examples, wherein the input object further comprises interactions associated with an editing user associated with an editing user identifier interacting with the extracted website elements prior to extraction from the one or more website building tools.

Example 6. An apparatus according to any of the foregoing Examples, further caused to: transmit, to a client computing device, the optimized webpage for rendering at least a portion of the optimized webpage via a display device of the client computing device.

Example 7. An apparatus according to any of the foregoing Examples, wherein the input object further comprises one or more of content, semantic features, or contextual features associated with the one or more website building tools.

Example 8. An apparatus according to any of the foregoing Examples, wherein the trained layout model comprises a neural network and is configured to generate the layout graph data structure based on inferring a hierarchical structure of a webpage associated with the input object.

Example 9. An apparatus according to any of the foregoing Examples, wherein the trained layout model is further configured to generate the layout graph data structure based on predicting semantics associated with groups and structural elements of the hierarchical structure of the webpage.

Example 10. An apparatus according to any of the foregoing Examples, wherein the trained layout model is further configured to generate a confidence score for a semantic prediction associated with a group or structural element of the hierarchical structure of the webpage.

Example 11. An apparatus according to any of the foregoing Examples, wherein the layout graph data structure represents the hierarchical structure of the webpage.

Example 12. An apparatus according to any of the foregoing Examples, wherein the layout graph data structure comprises elements of the webpage, relationships between the elements of the webpage, and semantics associated with the elements of the webpage.

Example 13. An apparatus according to any of the foregoing Examples, wherein the layout graph data structure is generated based on a multi-dimensional graph generated based on the extracted website elements, the multi-dimensional graph comprising a plurality of nodes and a plurality of edges, wherein an edge of the plurality of edges represents a relationship between two or more nodes of the plurality of nodes.

Example 14. An apparatus according to any of the foregoing Examples, wherein a node of the plurality of nodes represents a visual element of the elements of the webpage and an edge of the plurality of edges represents a containment relationship between two or more visual elements.

Example 15. An apparatus according to any of the foregoing Examples, wherein a node of the plurality of nodes is associated with a node identifier, a node index, an element size, an element position, textual attributes, and children node identifiers.

Example 16. An apparatus according to any of the foregoing Examples, wherein the edge further represents one or more of an explicit anchor, an automatic anchor, a semi-automatic anchor, or a gate condition.

Example 17. An apparatus according to any of the foregoing Examples, wherein the trained layout model is configured to apply post-processing when generating the layout graph data structure.

Example 18. An apparatus according to any of the foregoing Examples, wherein the trained layout model is configured to: group structural elements of the webpage based on predicted semantics associated with the structural elements; and predict semantics of the resulting groups of structural elements.

Example 19. An apparatus according to any of the foregoing Examples, wherein the trained layout model is further configured to apply vision-based object detection to compute pixel-level candidates of visual elements for inclusion in a group of structural elements.

Example 20. An apparatus according to any of the foregoing Examples, wherein the trained layout model is further configured to generate a pattern to capture text attributes of a text element.

Example 21. An apparatus according to any of the foregoing Examples, wherein the trained structure optimization model is configured to generate the webpage layout data structure based on the input object, the layout graph data structure, semantic predictions for groups and structural elements of a webpage associated with the input object, confidence scores associated with the semantic predictions, design intent of an editing user associated with the input object, and user preferences associated with the editing user.

Example 22. An apparatus according to any of the foregoing Examples, wherein the trained structure optimization model is configured to apply one or more of grouping, stacking, or placement of structural elements of the webpage.

Example 23. An apparatus according to any of the foregoing Examples, wherein the design intent or the user preferences are determined based on one or more of design or layout patterns associated with websites associated with the editing user, design system guidelines, or interactions with a user interface performed by the editing user.

Example 24. An apparatus according to any of the foregoing Examples, wherein the trained structure optimization model is a trained machine learning model configured to generate variations of the webpage layout data structure by varying parameters of layout techniques.

Example 25. An apparatus according to any of the foregoing Examples, wherein the trained responsive optimization model is a trained machine learning model configured to be retrained using historical website editing interactions, editing user intent, website data, and system design guidelines.

Example 26. An apparatus according to any of the foregoing Examples, wherein the trained responsive optimization model is configured to adjust one or more of structure, style, or layout of a webpage to result in the optimized webpage rendering according to the plurality of screen parameters.

Example 27. An apparatus according to any of the foregoing Examples, wherein the trained responsive optimization model is configured to apply breakpoint transformations to a webpage to result in the optimized webpage rendering according to the plurality of screen parameters.

Example 28. An apparatus according to any of the foregoing Examples, wherein the breakpoint transformations comprise one or more of text wrapping, element resizing, element hiding, element repositioning, element reordering, element alignment, layout adaptation, or style changing, group alignment, space adjusting, element property adjusting, breakpoint parameter tuning, or transforming horizontal elements to vertical elements.

Example 29. An apparatus according to any of the foregoing Examples, wherein the breakpoint parameter tuning comprises tuning an amount of padding needed, tuning a scaling behavior of images, tuning a sizing of text and button components, or tuning an overall packing of the webpage.

Example 30. An apparatus according to any of the foregoing Examples, wherein the plurality of screen parameters comprise one or more of a screen width, a screen height, a screen orientation, or target breakpoints.

Example 31. An apparatus according to any of the foregoing Examples, wherein the trained responsive optimization model is a heuristic model.

Example 32. An apparatus according to any of the foregoing Examples, wherein the heuristic model defines aesthetic objectives for website layouts such that the optimized webpage renders according to the plurality of screen parameters.

Example 33. An apparatus according to any of the foregoing Examples, wherein the one or more website building tools comprise one or more of pages, sub-pages, containers, components, atomic components, content elements, layout elements, templates, layouts, layout rules, add-on applications, third-party applications, procedural code, or application programming interfaces.

Example 34. At least one non-transitory computer-readable storage medium comprising instructions that, when executed by one or more processors, cause the one or more processors to: generate, based on applying a trained layout model to extracted website elements from an input object comprising one or more website building tools, a layout graph data structure; generate, based on applying a trained structure optimization model to the layout graph data structure, a webpage layout data structure; and generate, based on applying a trained responsive optimization model to the webpage layout data structure and a plurality of screen parameters, an optimized webpage that is configured to render according to the plurality of screen parameters.

Example 35. At least one non-transitory computer-readable storage medium according to the foregoing Example, wherein the one or more processors are further caused to: receive, from a client computing entity, the input object.

Example 36. At least one non-transitory computer-readable storage medium according to any of the foregoing Examples, wherein the input object further comprises historical website editing interactions associated with one or more of a first website editing user identified associated with the optimized webpage or a plurality of website editing users associated with a website building system with which the optimized webpage is being assembled.

Example 37. At least one non-transitory computer-readable storage medium according to any of the foregoing Examples, wherein the input object further comprises an input file.

Example 38. At least one non-transitory computer-readable storage medium according to any of the foregoing Examples, wherein the input object further comprises interactions associated with an editing user associated with an editing user identifier interacting with the extracted website elements prior to extraction from the one or more website building tools.

Example 39. At least one non-transitory computer-readable storage medium according to any of the foregoing Examples, wherein the one or more processors are further caused to: transmit, to a client computing device, the optimized webpage for rendering at least a portion of the optimized webpage via a display device of the client computing device.

Example 40. At least one non-transitory computer-readable storage medium according to any of the foregoing Examples, wherein the input object further comprises one or more of content, semantic features, or contextual features associated with the one or more website building tools.

Example 41. At least one non-transitory computer-readable storage medium according to any of the foregoing Examples, wherein the trained layout model comprises a neural network and is configured to generate the layout graph data structure based on inferring a hierarchical structure of a webpage associated with the input object.

Example 42. At least one non-transitory computer-readable storage medium according to any of the foregoing Examples, wherein the trained layout model is further configured to generate the layout graph data structure based on predicting semantics associated with groups and structural elements of the hierarchical structure of the webpage.

Example 43. At least one non-transitory computer-readable storage medium according to any of the foregoing Examples, wherein the trained layout model is further configured to generate a confidence score for a semantic prediction associated with a group or structural element of the hierarchical structure of the webpage.

Example 44. At least one non-transitory computer-readable storage medium according to any of the foregoing Examples, wherein the layout graph data structure represents the hierarchical structure of the webpage.

Example 45. At least one non-transitory computer-readable storage medium according to any of the foregoing Examples, wherein the layout graph data structure comprises elements of the webpage, relationships between the elements of the webpage, and semantics associated with the elements of the webpage.

Example 46. At least one non-transitory computer-readable storage medium according to any of the foregoing Examples, wherein the layout graph data structure is generated based on a multi-dimensional graph generated based on the extracted website elements, the multi-dimensional graph comprising a plurality of nodes and a plurality of edges, wherein an edge of the plurality of edges represents a relationship between two or more nodes of the plurality of nodes.

Example 47. At least one non-transitory computer-readable storage medium according to any of the foregoing Examples, wherein a node of the plurality of nodes represents a visual element of the elements of the webpage and an edge of the plurality of edges represents a containment relationship between two or more visual elements.

Example 48. At least one non-transitory computer-readable storage medium according to any of the foregoing Examples, wherein a node of the plurality of nodes is associated with a node identifier, a node index, an element size, an element position, textual attributes, and children node identifiers.

Example 49. At least one non-transitory computer-readable storage medium according to any of the foregoing Examples, wherein the edge further represents one or more of an explicit anchor, an automatic anchor, a semi-automatic anchor, or a gate condition.

Example 50. At least one non-transitory computer-readable storage medium according to any of the foregoing Examples, wherein the trained layout model is configured to apply post-processing when generating the layout graph data structure.

Example 51. At least one non-transitory computer-readable storage medium according to any of the foregoing Examples, wherein the trained layout model is configured to: group structural elements of the webpage based on predicted semantics associated with the structural elements; and predict semantics of the resulting groups of structural elements.

Example 52. At least one non-transitory computer-readable storage medium according to any of the foregoing Examples, wherein the trained layout model is further configured to apply vision-based object detection to compute pixel-level candidates of visual elements for inclusion in a group of structural elements.

Example 53. At least one non-transitory computer-readable storage medium according to any of the foregoing Examples, wherein the trained layout model is further configured to generate a pattern to capture text attributes of a text element.

Example 54. At least one non-transitory computer-readable storage medium according to any of the foregoing Examples, wherein the trained structure optimization model is configured to generate the webpage layout data structure based on the input object, the layout graph data structure, semantic predictions for groups and structural elements of a webpage associated with the input object, confidence scores associated with the semantic predictions, design intent of an editing user associated with the input object, and user preferences associated with the editing user.

Example 55. At least one non-transitory computer-readable storage medium according to any of the foregoing Examples, wherein the trained structure optimization model is configured to apply one or more of grouping, stacking, or placement of structural elements of the webpage.

Example 56. At least one non-transitory computer-readable storage medium according to any of the foregoing Examples, wherein the design intent or the user preferences are determined based on one or more of design or layout patterns associated with websites associated with the editing user, design system guidelines, or interactions with a user interface performed by the editing user.

Example 57. At least one non-transitory computer-readable storage medium according to any of the foregoing Examples, wherein the trained structure optimization model is a trained machine learning model configured to generate variations of the webpage layout data structure by varying parameters of layout techniques.

Example 58. At least one non-transitory computer-readable storage medium according to any of the foregoing Examples, wherein the trained responsive optimization model is a trained machine learning model configured to be retrained using historical website editing interactions, editing user intent, website data, and system design guidelines.

Example 59. At least one non-transitory computer-readable storage medium according to any of the foregoing Examples, wherein the trained responsive optimization model is configured to adjust one or more of structure, style, or layout of a webpage to result in the optimized webpage rendering according to the plurality of screen parameters.

Example 60. At least one non-transitory computer-readable storage medium according to any of the foregoing Examples, wherein the trained responsive optimization model is configured to apply breakpoint transformations to a webpage to result in the optimized webpage rendering according to the plurality of screen parameters.

Example 61. At least one non-transitory computer-readable storage medium according to any of the foregoing Examples, wherein the breakpoint transformations comprise one or more of text wrapping, element resizing, element hiding, element repositioning, element reordering, element alignment, layout adaptation, or style changing, group alignment, space adjusting, element property adjusting, breakpoint parameter tuning, or transforming horizontal elements to vertical elements.

Example 62. At least one non-transitory computer-readable storage medium according to any of the foregoing Examples, wherein the breakpoint parameter tuning comprises tuning an amount of padding needed, tuning a scaling behavior of images, tuning a sizing of text and button components, or tuning an overall packing of the webpage.

Example 63. At least one non-transitory computer-readable storage medium according to any of the foregoing Examples, wherein the plurality of screen parameters comprise one or more of a screen width, a screen height, a screen orientation, or target breakpoints.

Example 64. At least one non-transitory computer-readable storage medium according to any of the foregoing Examples, wherein the trained responsive optimization model is a heuristic model.

Example 65. At least one non-transitory computer-readable storage medium according to any of the foregoing Examples, wherein the heuristic model defines aesthetic objectives for website layouts such that the optimized webpage renders according to the plurality of screen parameters.

Example 66. At least one non-transitory computer-readable storage medium according to any of the foregoing Examples, wherein the one or more website building tools comprise one or more of pages, sub-pages, containers, components, atomic components, content elements, layout elements, templates, layouts, layout rules, add-on applications, third-party applications, procedural code, or application programming interfaces.

Example 67. A computer-implemented method, comprising: generating, based on applying a trained layout model to extracted website elements from an input object comprising one or more website building tools, a layout graph data structure; generating, based on applying a trained structure optimization model to the layout graph data structure, a webpage layout data structure; and generating, based on applying a trained responsive optimization model to the webpage layout data structure and a plurality of screen parameters, an optimized webpage that is configured to render according to the plurality of screen parameters.

Example 68. A computer-implemented method according to the foregoing Example, further comprising: receiving, from a client computing entity, the input object.

Example 69. A computer-implemented method according to any of the foregoing Examples, wherein the input object further comprises historical website editing interactions associated with one or more of a first website editing user identified associated with the optimized webpage or a plurality of website editing users associated with a website building system with which the optimized webpage is being assembled.

Example 70. A computer-implemented method according to any of the foregoing Examples, wherein the input object further comprises an input file.

Example 71. A computer-implemented method according to any of the foregoing Examples, wherein the input object further comprises interactions associated with an editing user associated with an editing user identifier interacting with the extracted website elements prior to extraction from the one or more website building tools.

Example 72. A computer-implemented method according to any of the foregoing Examples, further comprising: transmitting, to a client computing device, the optimized webpage for rendering at least a portion of the optimized webpage via a display device of the client computing device.

Example 73. A computer-implemented method according to any of the foregoing Examples, wherein the input object further comprises one or more of content, semantic features, or contextual features associated with the one or more website building tools.

Example 74. A computer-implemented method according to any of the foregoing Examples, wherein the trained layout model comprises a neural network and is configured to generate the layout graph data structure based on inferring a hierarchical structure of a webpage associated with the input object.

Example 75. A computer-implemented method according to any of the foregoing Examples, wherein the trained layout model is further configured to generate the layout graph data structure based on predicting semantics associated with groups and structural elements of the hierarchical structure of the webpage.

Example 76. A computer-implemented method according to any of the foregoing Examples, wherein the trained layout model is further configured to generate a confidence score for a semantic prediction associated with a group or structural element of the hierarchical structure of the webpage.

Example 77. A computer-implemented method according to any of the foregoing Examples, wherein the layout graph data structure represents the hierarchical structure of the webpage.

Example 78. A computer-implemented method according to any of the foregoing Examples, wherein the layout graph data structure comprises elements of the webpage, relationships between the elements of the webpage, and semantics associated with the elements of the webpage.

Example 79. A computer-implemented method according to any of the foregoing Examples, wherein the layout graph data structure is generated based on a multi-dimensional graph generated based on the extracted website elements, the multi-dimensional graph comprising a plurality of nodes and a plurality of edges, wherein an edge of the plurality of edges represents a relationship between two or more nodes of the plurality of nodes.

Example 80. A computer-implemented method according to any of the foregoing Examples, wherein a node of the plurality of nodes represents a visual element of the elements of the webpage and an edge of the plurality of edges represents a containment relationship between two or more visual elements.

Example 81. A computer-implemented method according to any of the foregoing Examples, wherein a node of the plurality of nodes is associated with a node identifier, a node index, an element size, an element position, textual attributes, and children node identifiers.

Example 82. A computer-implemented method according to any of the foregoing Examples, wherein the edge further represents one or more of an explicit anchor, an automatic anchor, a semi-automatic anchor, or a gate condition.

Example 83. A computer-implemented method according to any of the foregoing Examples, wherein the trained layout model is configured to apply post-processing when generating the layout graph data structure.

Example 84. A computer-implemented method according to any of the foregoing Examples, wherein the trained layout model is configured to: group structural elements of the webpage based on predicted semantics associated with the structural elements; and predict semantics of the resulting groups of structural elements.

Example 85. A computer-implemented method according to any of the foregoing Examples, wherein the trained layout model is further configured to apply vision-based object detection to compute pixel-level candidates of visual elements for inclusion in a group of structural elements.

Example 86. A computer-implemented method according to any of the foregoing Examples, wherein the trained layout model is further configured to generate a pattern to capture text attributes of a text element.

Example 87. A computer-implemented method according to any of the foregoing Examples, wherein the trained structure optimization model is configured to generate the webpage layout data structure based on the input object, the layout graph data structure, semantic predictions for groups and structural elements of a webpage associated with the input object, confidence scores associated with the semantic predictions, design intent of an editing user associated with the input object, and user preferences associated with the editing user.

Example 88. A computer-implemented method according to any of the foregoing Examples, wherein the trained structure optimization model is configured to apply one or more of grouping, stacking, or placement of structural elements of the webpage.

Example 89. A computer-implemented method according to any of the foregoing Examples, wherein the design intent or the user preferences are determined based on one or more of design or layout patterns associated with websites associated with the editing user, design system guidelines, or interactions with a user interface performed by the editing user.

Example 90. A computer-implemented method according to any of the foregoing Examples, wherein the trained structure optimization model is a trained machine learning model configured to generate variations of the webpage layout data structure by varying parameters of layout techniques.

Example 91. A computer-implemented method according to any of the foregoing Examples, wherein the trained responsive optimization model is a trained machine learning model configured to be retrained using historical website editing interactions, editing user intent, website data, and system design guidelines.

Example 92. A computer-implemented method according to any of the foregoing Examples, wherein the trained responsive optimization model is configured to adjust one or more of structure, style, or layout of a webpage to result in the optimized webpage rendering according to the plurality of screen parameters.

Example 93. A computer-implemented method according to any of the foregoing Examples, wherein the trained responsive optimization model is configured to apply breakpoint transformations to a webpage to result in the optimized webpage rendering according to the plurality of screen parameters.

Example 94. A computer-implemented method according to any of the foregoing Examples, wherein the breakpoint transformations comprise one or more of text wrapping, element resizing, element hiding, element repositioning, element reordering, element alignment, layout adaptation, or style changing, group alignment, space adjusting, element property adjusting, breakpoint parameter tuning, or transforming horizontal elements to vertical elements.

Example 95. A computer-implemented method according to any of the foregoing Examples, wherein the breakpoint parameter tuning comprises tuning an amount of padding needed, tuning a scaling behavior of images, tuning a sizing of text and button components, or tuning an overall packing of the webpage.

Example 96. A computer-implemented method according to any of the foregoing Examples, wherein the plurality of screen parameters comprise one or more of a screen width, a screen height, a screen orientation, or target breakpoints.

Example 97. A computer-implemented method according to any of the foregoing Examples, wherein the trained responsive optimization model is a heuristic model.

Example 98. A computer-implemented method according to any of the foregoing Examples, wherein the heuristic model defines aesthetic objectives for website layouts such that the optimized webpage renders according to the plurality of screen parameters.

Example 99. A computer-implemented method according to any of the foregoing Examples, wherein the one or more website building tools comprise one or more of pages, sub-pages, containers, components, atomic components, content elements, layout elements, templates, layouts, layout rules, add-on applications, third-party applications, procedural code, or application programming interfaces.

### CONCLUSION

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims.

1. An apparatus comprising one or more processors and at least one non-transitory computer-readable storage medium comprising instructions that, when executed by the one or more processors, cause the apparatus to:
generate, based on applying a trained layout model to extracted website elements from an input object comprising one or more website building tools, a layout graph data structure;
generate, based on applying a trained structure optimization model to the layout graph data structure, a webpage layout data structure; and
generate, based on applying a trained responsive optimization model to the webpage layout data structure and a plurality of screen parameters, an optimized webpage that is configured to render according to the plurality of screen parameters.

2. (canceled)

3. The apparatus of claim 1, wherein the input object further comprises historical website editing interactions associated with one or more of a first website editing user identified associated with the optimized webpage or a plurality of website editing users associated with a website building system with which the optimized webpage is being assembled.

4. The apparatus of claim 1, wherein the input object further comprises one or more of an input file, content, semantic features, or contextual features associated with the one or more website building tools.

5. The apparatus of claim 1, wherein the input object further comprises interactions associated with an editing user associated with an editing user identifier interacting with the extracted website elements prior to extraction from the one or more website building tools.

6. The apparatus of claim 1, wherein the apparatus is further caused to:
transmit, to a client computing device, the optimized webpage for rendering at least a portion of the optimized webpage via a display device of the client computing device.

7. (canceled)

8. The apparatus of claim 1, wherein the trained layout model comprises a neural network and is configured to generate the layout graph data structure based on one or more of inferring a hierarchical structure of a webpage associated with the input object or predicting semantics associated with groups and structural elements of the hierarchical structure of the webpage.

9. (canceled)

10. The apparatus of claim 8, wherein the trained layout model is further configured to generate a confidence score for a semantic prediction associated with a group or structural element of the hierarchical structure of the webpage.

11. The apparatus of claim 8, wherein the layout graph data structure represents the hierarchical structure of the webpage and comprises one or more of elements of the webpage, relationships between the elements of the webpage, or semantics associated with the elements of the webpage.

12. (canceled)

13. The apparatus of claim 11, wherein the layout graph data structure is generated based on a multi-dimensional graph generated based on the extracted website elements, the multi-dimensional graph comprising a plurality of nodes and a plurality of edges, wherein an edge of the plurality of edges represents a relationship between two or more nodes of the plurality of nodes.

14. The apparatus of claim 13, wherein a node of the plurality of nodes represents a visual element of the elements of the webpage and an edge of the plurality of edges represents one or more of a containment relationship between two or more visual elements, an explicit anchor, an automatic anchor, a semi-automatic anchor, or a gate condition.

15-16. (canceled)

17. The apparatus of claim 1, wherein the trained layout model is configured to one or more of
(a) apply post-processing when generating the layout graph data structure, or
(b) group structural elements of the webpage based on predicted semantics associated with the structural elements and predict semantics of the resulting groups of structural elements.

18-19. (canceled)

20. The apparatus of claim 8, wherein the trained layout model is further configured to generate a pattern to capture text attributes of a text element.

21. The apparatus of claim 1, wherein the trained structure optimization model is configured to generate the webpage layout data structure based on the input object, the layout graph data structure, semantic predictions for groups and structural elements of a webpage associated with the input object, confidence scores associated with the semantic predictions, design intent of an editing user associated with the input object, and user preferences associated with the editing user.

22. The apparatus of claim 21, wherein the trained structure optimization model is configured to apply one or more of grouping, stacking, or placement of structural elements of the webpage.

23. (canceled)

24. The apparatus of claim 21, wherein the trained structure optimization model is a trained machine learning model configured to one or more of generate variations of the webpage layout data structure by varying parameters of layout techniques or be retrained using historical website editing interactions, editing user intent, website data, and system design guidelines.

25. (canceled)

26. The apparatus of claim 1, wherein the trained responsive optimization model is configured to one or more of adjust one or more of structure, style, or layout of a webpage or apply breakpoint transformations to a webpage to result in the optimized webpage rendering according to the plurality of screen parameters.

27. (canceled)

28. The apparatus of claim 26, wherein the breakpoint transformations comprise one or more of text wrapping, element resizing, element hiding, element repositioning, element reordering, element alignment, layout adaptation, or style changing, group alignment, space adjusting, element property adjusting, breakpoint parameter tuning, or transforming horizontal elements to vertical elements, wherein the breakpoint parameter tuning comprises tuning an amount of padding needed, tuning a scaling behavior of images, tuning a sizing of text and button components, or tuning an overall packing of the webpage.

29. (canceled)

30. The apparatus of claim 1, wherein the plurality of screen parameters comprise one or more of a screen width, a screen height, a screen orientation, or target breakpoints.

31. The apparatus of claim 1, wherein the trained responsive optimization model is a heuristic model that defines aesthetic objectives for website layouts such that the optimized webpage renders according to the plurality of screen parameters.

32. (canceled)

33. The apparatus of claim 1, wherein the one or more website building tools comprise one or more of pages, sub-pages, containers, components, atomic components, content elements, layout elements, templates, layouts, layout rules, add-on applications, third-party applications, procedural code, or application programming interfaces.

34-99. (canceled)
